(19) United States
(12) Patent Application Publication
(10) Pub. No.: US 2025/0356857 A1
(43) Pub. Date: Nov. 20, 2025

(54) System and Method for Unified Cross-Device Control of Dispersed Applications Using Voice Commands and Intelligent Response Routing

(71) Applicant: Skywalk Inc., Palo Alto, CA (US)

(72) Inventors: Junrui Yang, Hayward, CA (US); Tyler Nai Ming Chen, Carlsbad, CA (US); Savannah Ashley Cofer, Lewis Center, OH (US)

(21) Appl. No.: 19/204,301

(22) Filed: May 9, 2025

Related U.S. Application Data
(60) Provisional application No. 63/648,379, filed on May 16, 2024.

(51) Int. Cl. G10L 15/30; G06F 21/32; G10L 15/22

(52) U.S. Cl. CPC G10L 15/30; G06F 21/32; G10L 15/22; G10L 2015/223; G10L 2015/228

(57) ABSTRACT

A system and method for cross-device application control employs peripheral devices that emulate standardized human interface device (HID) protocols to control host devices without the need for operating system level access. The system processes voice commands through a routing application on a host device and transmits them with contextual information to a cloud-based AI model. When access authorization exists, the AI-generated response is directly executed; otherwise, it's reformatted according to HID specifications and transmitted through an emulated keyboard interface. This technique establishes authorized communication channels to otherwise inaccessible applications, enabling cross-platform control without specialized integration. The system collects context from both host devices and target applications to enhance response accuracy, with implementations for context processing including device-based integration and unified cloud processing.

### CROSS-REFERENCE TO RELATED APPLICATIONS

This application is related to and claims the benefit of priority of U.S. Provisional Patent Application Ser. No. 63/648,379 filed on May 16, 2024, entitled “System and Method for providing a single unified model for taking actions on behalf of users in disperse target applications, and the entire contents of which are hereby incorporated by reference.

### FIELD OF THE PRESENT TECHNOLOGY

The present technology relates generally to intelligent voice-based assistant systems, and more specifically to systems, methods and devices for interacting with multiple applications across various devices through voice commands processed by AI models.

### BACKGROUND

Mobile phone users face several challenges when working across different applications and devices. These include compatibility issues between platforms, limited integration between apps, device-specific limitations, and workflow disruptions when switching between devices. For example, copying text from a phone app to a laptop browser is often difficult, certain apps may have different features across devices, and moving tasks between devices can be time-consuming.

Users would benefit from a unified AI assistant that could perform actions in any application across all their devices. However, this is challenging due to security restrictions in modern operating systems, particularly on mobile devices. Key challenges include how to capture user requests, how to route AI responses to the correct applications, and how to incorporate contextual information to improve AI responses.

Users want to access AI assistance without opening dedicated apps and prefer private voice control methods that don't disrupt their surroundings.

Cross-application control presents significant barriers. Third-party apps cannot control other apps (like Salesforce AI cannot input data into Norton), access built-in apps (like Salesforce AI cannot work with Apple Notes), or integrate with apps that haven't explicitly allowed it. Additionally, no current solution allows apps on one device to control apps on another device platform, for example, Apple's Siri cannot control Windows applications.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

One aspect of the present technology is to provide systems and methods for controlling multiple applications across different devices through voice commands that incorporate relevant environmental, personal and application-specific information.

Another aspect of the present technology is to overcome cross-platform compatibility issues where applications may not be optimized for interoperability across various devices, leading to inconsistencies in user experience.

Still another aspect of the present technology is to address limited integration capabilities in many applications that make it difficult for users to complete cross-platform tasks seamlessly without interruption across different platforms

Another aspect of the present technology is to provide a single unified AI model that can take actions on behalf of the user in any target application running on any of the user's personal devices despite security and access restrictions between operating systems and software.

Yet another aspect of the present technology is to provide methods for capturing user requests for AI assistance without disrupting workflow, allowing users to remain in their current applications rather than switching to dedicated AI interfaces.

An additional aspect of the present technology is to establish precise mechanisms for delivering AI-generated responses to their intended destinations, ensuring actions are executed in the correct application regardless of which device the user is currently using.

Still another aspect of the present technology is to provide methods for passing contextual information into an AI model, alongside user input, to better fulfill user requests and enhance response accuracy.

Another aspect of the present technology is to enable third-party applications to take action on behalf of their users in other applications that would normally be inaccessible due to platform restrictions or lack of explicit integration, including resident applications and applications on different devices.

A further aspect of the present technology is to provide users who prefer voice input with methods to interact with dispersed target applications in a secure and private manner, undetectable by third parties in proximity.

Still another aspect of the present technology is to enable hands-free user interaction with multiple applications in a conversational manner using natural language.

Additional aspect, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

According to one example embodiment, there is provided a system for cross-device application control using voice commands, the system comprising, a host device comprising a memory storing a routing application including program instructions, and a processor coupled to the memory and configured by the program instructions to: receive, from a peripheral device, audio data corresponding to a spoken voice command intended to control a target application; process the audio data to generate a processed representation of the spoken voice command; retrieve contextual information related to at least one of: a host device environment, user preferences, or a target application state; transmit the processed representation of the spoken voice command and the contextual information to a remote AI model server; receive, from the remote AI model server, a structured response generated based on the processed representation of the spoken voice command and the contextual information; determine whether the host device provides access authorization permitting the routing application to interact with the target application; upon determining that the host device provides the access authorization, execute, based on the structured response, a control action in the target application; and upon determining that the host device does not provide the access authorization: transmit the structured response to the peripheral device; configure the peripheral device to reformat the structured response according to an accepted input specification; and transmit the reformatted structured response to the target application causing execution of the control action in the target application.

According to one example embodiment, there is provided a method for cross-device application control using voice commands, the method comprising: receiving, at a host device from a peripheral device, audio data corresponding to a spoken voice command intended to control a target application; processing the audio data to generate a processed representation of the spoken voice command; retrieving contextual information related to at least one of: a host device environment, user preferences, or a target application state; transmitting the processed representation of the spoken voice command and the contextual information to a remote AI model server; receiving, from the remote AI model server, a structured response generated based on the processed representation of the spoken voice command and the contextual information; determining whether the host device provides access authorization permitting interaction with the target application; upon determining that the host device provides the access authorization, executing, based on the structured response, a control action in the target application; and upon determining that the host device does not provide the access authorization: transmitting the structured response to the peripheral device; configuring the peripheral device to reformat the structured response according to an accepted input specification; and transmitting the reformatted structured response to the target application causing execution of the control action in the target application.

According to one example embodiment, there is provided a non-transitory computer-readable medium storing program instructions that, when executed by a processor of a host device, cause the host device to implement operations comprising: receiving, at a host device from a peripheral device, audio data corresponding to a spoken voice command intended to control a target application; processing the audio data to generate a processed representation of the spoken voice command; retrieving contextual information related to at least one of: a host device environment, user preferences, or a target application state; transmitting the processed representation of the spoken voice command and the contextual information to a remote AI model server; receiving, from the remote AI model server, a structured response generated based on the processed representation of the spoken voice command and the contextual information; determining whether the host device provides access authorization permitting interaction with the target application; upon determining that the host device provides the access authorization, executing, based on the structured response, a control action in the target application; and upon determining that the host device does not provide the access authorization: transmitting the structured response to the peripheral device; configuring the peripheral device to reformat the structured response according to an accepted input specification; and transmitting the reformatted structured response to the target application causing execution of the control action in the target application.

According to one example embodiment of the present technology, the system implements a direct audio transmission path way that eliminates the processing of audio data on the host device. In this configuration, the audio data corresponding to the spoken voice command is received from the peripheral device and transmitted directly to the remote AI model server without further audio processing on the host device. This approach leverages the computational capabilities of the cloud system to perform all necessary decompression, speech-to-text conversion (if required), and linguistic analysis, reducing processing overhead on the host device and potentially decreasing latency when the host device has limited processing resources. The system still retrieves relevant contextual information as described previously, transmitting this alongside the unprocessed audio data to ensure the AI model has sufficient information to generate an appropriate structured response. Upon receiving the AI-generated structured response, the system follows the same decision pathway regarding access authorization and execution described in the primary embodiment, either executing the control action directly when authorization exists or employing the emulated input pathway when it does not. This direct audio transmission embodiment may be particularly advantageous in situations where maintaining the acoustic characteristics of the original speech is important for specialized AI analysis from AI models that receive audio as an input or where the host device has power or computational constraints.

Other example embodiments of the disclosure and aspects will become apparent from the following description taken in conjunction with the following drawings.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a diagram of a system architecture for practicing aspects of the invention.

FIG. 2 is a timeline diagram illustrating the method's operational sequence.

FIG. 3 is a diagram showing direct integration between the routing application (A1) and target application (A2).

FIG. 4 is a diagram illustrating detailed aspects of method steps 1-3 with Wi-Fi enabled peripheral connectivity.

FIG. 5 is a diagram showing the emulated input device implementation.

FIG. 6 is a diagram illustrating signal processing methods applied to multi-channel audio input.

FIG. 7 is a diagram showing multichannel audio capture from in-ear/out-ear microphones.

FIG. 8 is a diagram showing the routing application (A1) utilizing an automatic speech recognition model (ASR).

FIG. 9 is a diagram illustrating audio feedback mechanisms between the routing application and peripheral device.

FIG. 10 is a diagram illustrating collaborative application interaction during method STEP 3.

FIG. 11 is a diagram showing bidirectional context management during method STEP 3.

FIG. 12 is a diagram illustrating earbud case handling of protocol reformatting during STEP 5.

FIG. 13 is a diagram showing alternate audio capture configurations using either earbud case or wireless earbuds.

FIG. 14 is a diagram illustrating contextual parameter transmission during method STEP 1.

FIG. 15 is a diagram showing method STEPS 3-7 at a higher abstraction level.

FIG. 16 is a diagram illustrating the intelligent routing mechanism for steps 6-7.

FIG. 17 is a diagram showing context-aware routing intelligence for steps 6-7.

FIG. 18 is a diagram illustrating dynamic command transformation for cross-device compatibility

FIG. 19 is a diagram showing how personal context influences command transformation for target devices.

FIG. 20 is a diagram showing how interaction history influences routing decisions.

FIG. 21 is a diagram illustrating dual context pathways during steps 3, 3A and 4.

FIG. 22 is a diagram showing direct cloud-to-cloud communication during STEPS 3, 3A and 3B.

FIG. 23 is a diagram illustrating unified cloud processing for context integration.

FIG. 24 is a simplified block diagram of an exemplary system that is used to implement embodiments according to the present technology

### DETAILED DESCRIPTION OF EXAMPLE EMBODIMENTS

Embodiments of the present technology and examples thereof will now be described more fully in detail hereinafter with reference to the accompanying drawings. In the drawings, elements may be shown schematically for ease of understanding. Also, like numerals are used to designate like elements throughout the drawings.

### Definitions

In addition, the terminology used herein for the purpose of describing particular embodiments of the present technology is to be taken in context. For example, the term “comprises” or “comprising” when used in this disclosure indicates the presence of stated features in a system or steps in a process but does not preclude the presence of additional features or steps.

The term “whispered speech” or “whispered voice” refers to speech spoken entirely without vibration of the vocal folds and thereby having a different characteristic spectrum as compared to voiced speech. Whispered speech is typically low signal-to-noise, spoken quietly enough that an observer in a quiet environment (ambient noise level not exceeding about 30 dB sound pressure level (SPL)) and only a few feet from the speaker is unable to hear and discern, and occurs similarly at a level of approximately 20-30 dB SPL, i.e., greater than the level of sound of normal breathing and substantially less than the level of sound of normal conversation which is about 60 dB SPL.

The term “voiced speech” may thus be understood as referring to speech spoken aloud at substantially the level of normal conversation (i.e., at a level of approximately 60 dB SPL).

The term “low signal-to-noise ratio” or “low (SNR)” is a term of art well understood by persons in the field of voice technology and generally refers to values where the speech signal is of a lower intensity than the background noise signal. The term “low signal-to-noise ratio” in the context of the present technology can pertain to whispered speech and voiced speech depending on the environment and will be understood as encompassing speech that an observer only a few feet away from the speaker cannot discern through hearing.

The term “voice command” will be understood as any type of practically usable command generated from a user's speech, i.e., a text or audio command. The term “recording” may also be understood as referring to the storing of certain data (signals) in a computer's memory. The term “signal” or “signals” may also each be understood as referring to a stream of signals from one or more sensors and the like.

The term “structured response” as used herein refers to output generated by the AI model after processing a voice command and associated contextual information. The structured response contains executable instructions, formatted data, and/or content specifically organized to enable routing to and execution by an appropriate target application or device. The structured response may include, but is not limited to, text, audio, images, multimodal content, function calls, control instructions, or formatted data entries that can be directly executed to perform a control action corresponding to the original voice command. The structured response typically comprises a standardized format with routing information and execution parameters that allow for proper interpretation across different target devices and applications, whether through direct API integration or human interface device emulation protocols. An example of a structured response could be a JavaScript Object Notation (JSON) object.

The term “routing application” is a software application that is configured to receive and transmit data between an input device (e.g., earbud peripheral device), a host device (e.g., mobile phone) and an AI model.

The term “target application” is one or more target applications that a user desires to interact with, via voice command. In different embodiments, the target application may be running on a host device (e.g., mobile phone) or a different device of the user.

The term ‘HID emulation’ or ‘emulated HID’ refers to a software-implemented technique wherein a peripheral device presents itself to a host device as a standard human interface device (HID), such as a keyboard or mouse, by implementing and advertising standardized HID protocols over wireless communication channels despite not having the form factor of a standard physical input device. This technique enables the peripheral device to transmit data formatted as standardized input device commands (such as keystrokes or cursor movements) that can be received and processed by any application configured to accept standard input, thereby establishing authorized communication channels to applications that would otherwise be inaccessible without modifying the source code of the application or the operating system itself. The emulation process involves several specific technical steps: (1) registering the peripheral device with the host operating system's Bluetooth stack using standard HID service UUIDs and descriptors; (2) implementing the report descriptor structure according to USB HID class specification that defines input report formats; (3) encoding the AI-generated responses into appropriate scan codes, key codes, or input events compliant with HID specifications; (4) transmitting these encoded inputs using an accepted Bluetooth HID protocol (e.g. using the Generic Attribute Profile (GATT); and (5) maintaining proper sequencing of input events to accurately simulate human interaction patterns. This approach enables cross-application and cross-device control while maintaining compatibility with existing security architectures because the host operating system processes these inputs through standard device drivers rather than through custom, potentially restricted APIs.

The term “accepted input specification” refers to a standardized protocol by which peripheral devices may transmit data to a target device, such that the operating system software running on the target device accepts the data as a native input. Examples of accepted input specifications include the human interface device (HID) class specifications as established by the USB Implementers Forum and audio protocol specifications such as the Hands Free Profile or Headset Profile as established by the Bluetooth Special Interest Group (SIG). For HID-based specifications specifically, an accepted HID input specification comprises: (1) a complete report descriptor structure that defines input, output, and feature report formats according to section 6.2 of the HID specification; (2) a set of standardized usage tables corresponding to specific input device types as defined in the HID Usage Tables specification document; (3) the required report format structures including report ID, data fields, and state information; and (4) the communication protocol parameters specific to the transport mechanism (e.g., Bluetooth HID over GATT or USB HID). In the context of the present technology, the most commonly implemented accepted HID input specifications include the HID keyboard specification (which defines standard keyboard scan codes, modifier keys, and keyboard-specific reports) and the HID mouse specification (which defines pointer movement, button state, and scroll wheel reports). The system reformats structured responses according to these accepted specifications to ensure compatibility with any host system capable of recognizing standard input devices.

Note, for brevity and ease of understanding, the present technology will be described mainly with respect to the recognition of whispered speech but as the present technology makes clear, the present technology is capable of recognizing other types of speech including, for example, low SNR speech and high SNR speech.

### Overview

The present technology improves upon voice assistants like Siri, Alexa, and Google Assistant in key ways. Current voice assistants can only control apps specifically designed for them or made by the same company. The present technology uses HID emulation to bypass these limitations completely. This enables the system to control any application that accepts keyboard or mouse input, even if that application has no built-in voice assistant support or does not present APIs for nontraditional input. This provides additional functionality for users of accessibility frameworks who may prefer to have an assistant control their devices without having to learn a new control framework for each device. Unlike current voice assistants that typically only work with devices from the same manufacturer (e.g., Apple devices with Siri, Amazon devices with Alexa), the present technology allows seamless control across different types of devices from different manufacturers, enabling users to control Windows applications from iOS devices, for example. The system implements a novel technical solution to the specific technical problem of cross-application and cross-device control limitations imposed by modern operating system security architectures. By utilizing a peripheral device that emulates standardized input protocols rather than attempting to directly bypass security restrictions, the invention achieves interoperability without compromising the underlying security model. The system's unique dual-context architecture combines both device information and application-specific information simultaneously, providing much more relevant responses than existing assistants that have limited awareness of what users are doing. This novel architecture overcomes key limitations of current voice assistants, which cannot: control apps without special integration, access protected fields in security-sensitive applications, perform actions across different device platforms in a single command, or maintain awareness of context when switching between devices. This represents an improvement to computer functionality that extends the capabilities of existing systems while maintaining their security integrity. For instance, the system enables previously impossible tasks such as dictating text into an arbitrary device with real-time AI editing or moving information between apps on different devices without manual copying and pasting tasks that existing voice assistants cannot perform due to security restrictions and their inability to work across different manufacturers' devices.

### EXAMPLE EMBODIMENTS

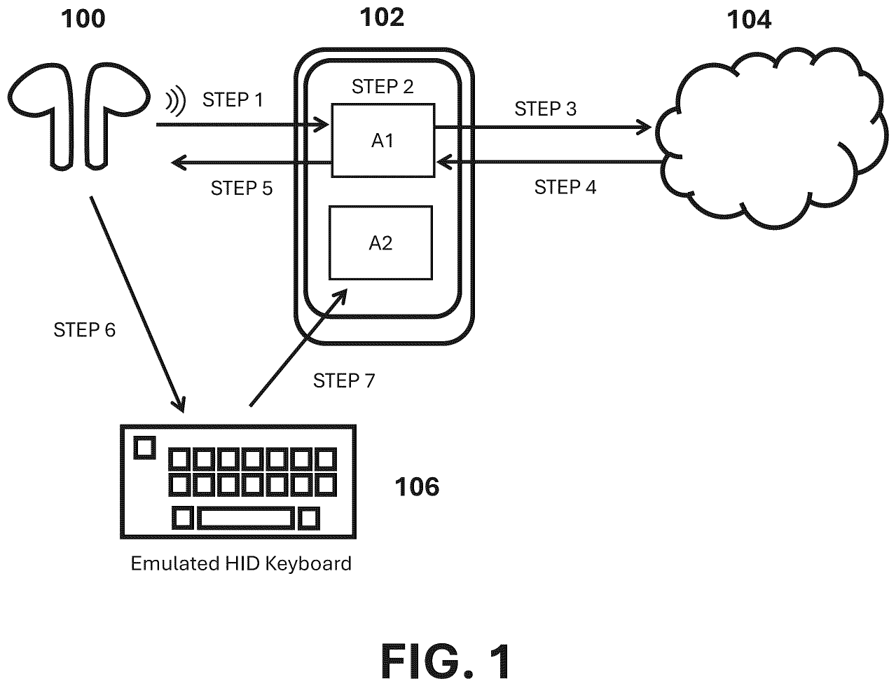

FIG. 1 is a diagram of an example system architecture for practicing aspects of the present technology, according to one embodiment. The system includes an earbud peripheral device 100, a mobile communication device 102 hosting a routing application (A1) and one or more target applications (A2), and a cloud system 104 hosting an AI model. The system also includes an emulated HID keyboard 106 functionality that enables communication between the earbud peripheral device 100 and the target application (A2).

In this context, an “emulated HID keyboard” refers to software functionality within the earbud peripheral device that allows it to impersonate or mimic a standard Bluetooth keyboard. HID (human interface device) is a standardized protocol that defines how input devices like keyboards and mice communicate with computers and mobile devices.

Rather than being a physical keyboard, this is a virtual implementation where the earbud peripheral device 100 presents itself to the mobile device 102 as if it were a standard Bluetooth keyboard. This HID input emulation enables the earbud to transmit text and commands to target applications (A2) in a format they are natively designed to accept, without requiring special integration or permissions.

The operation of the system begins with the earbud peripheral device 100 capturing user input data. This user input data may include audio data, whispered speech, normal speech, silent speech, text data, or image data. The earbud peripheral device 100 transmits this user input data to the routing application (A1) within the mobile communication device 102 via a communication link (shown as STEP 1 in FIG. 1). This communication may occur via various means including, but not limited to, GATT over BR/EDR or GATT over BLE Bluetooth protocols. The user provides this input data with the intention of interacting with a target application (A2), which may be running on the mobile communication device 102 or on another device not shown in FIG. 1.

Upon receiving the user input data from the earbud peripheral device 100, the routing application (A1) within the mobile communication device 102 processes this data as indicated by STEP 2 in FIG. 1. The processing performed by the routing application (A1) may include generating a local transcription of speech to text, compression of the user input data, or other transformations. In some embodiments, the user input data is multichannel audio data of the user's speech with one or more audio channels generated by sensors coupled to the user's body and configured to receive bone-conducted speech data, and one or more channels not coupled to the user's body and configured to receive ambient audio data.

The routing application (A1) may also perform several optional processing steps, including:

I—Retrieving additional context data from stored memory or other applications on the mobile communication device 102, including recently entered data, user interaction history, or device state information.

II—Retrieving context data from the target application (A2), such as the contents of the current active text field via a software-enabled mobile keyboard.

III—Retrieving an API key to authenticate the request alongside the processed data.

IV—Encrypting the data.

V—Retrieving payment information from the user through a prompt.

VI—Retrieving authentication information from the user through a prompt.

VII—Retrieving authentication or payment information from a cached location in memory.

VIII—Replacing sensitive information in the data (e.g., a password) with a non-sensitive placeholder.

IX—Sending an API request to retrieve context data from a connected account (e.g., a calendar), which can be received by either the routing application (A1) or queued for cloud system 104.

After completing these processing steps, the routing application (A1) transmits the processed data to cloud system 104 via the communication link shown as STEP 3 in FIG. 1. The system supports multiple alternative data collection methods for gathering and integrating contextual information alongside the user's voice command. These different approaches to context collection, described in the following paragraphs, enable the system to adapt to various usage scenarios and privacy considerations.

The system uses three types of contextual data: (1) Local context: information from the device itself, such as what is displayed on the screen, what app is running, and recent user inputs; (2) Personal context: user information like contacts, calendars, and preferences; and (3) Global context: general information like time, weather, and news. The system may collect these three context types using the different methods described below.

The first data collection method involves local collection only. All contextual data is gathered directly on the mobile communication device 102, without cloud retrieval of any context. For example, when a user issues a voice command “Reply to this email,” the system collects local context (e.g., the email content currently displayed on screen, recipient information, and previous messages in the thread), personal context (e.g., the user's email signature, writing style preferences, and relationship with the recipient stored in the device's contact database), and global context (e.g., current time and date from the device clock). This approach prioritizes privacy but may limit contextual richness to information available on the device.

The second data collection method uses a hybrid approach. Voice commands and local context are collected on the mobile device 102, while personal and global context data are retrieved from cloud system 104. For example, with the same “Reply to this email” command, the system collects local context (email content) from the device, but retrieves personal context (e.g., the user's communication history with the recipient across multiple platforms) and global context (e.g., relevant news or information that might be pertinent to the email topic) from cloud system 104. This approach balances privacy considerations with enhanced contextual richness.

The third data collection method minimizes local collection. Only the raw voice commands are gathered on the mobile device 102. All contextual information—local, personal, and global—is retrieved from cloud system 104. For example, when a user issues the command “Reply to this email,” only the command itself is received locally, while the email content (local context), user preferences and history (personal context), and relevant external information (global context) are all retrieved from synchronized cloud storage and the transcription of the command occurs in the cloud system 104. This approach optimizes for thin-client implementations where devices have limited processing capabilities or storage.

Regardless of which data collection method is employed, the system ultimately transmits all gathered information, both the voice command data and the contextual information, to cloud system 104 for processing. Cloud system 104 contains an AI model that processes this combined input data to generate an appropriate AI response. The AI model within cloud system 104 may be, for example, GPT4o or another generative AI model capable of producing various types of outputs including text, audio, video, function calls, actions, or multimodal responses.

When the routing application (A1) receives the AI-generated response from cloud system 104, it performs one of two distinct processing paths depending on access authorization

In the first processing path, when the host device provides appropriate access authorization allowing direct communication between applications, the routing application (A1) can execute control actions directly in the target application (A2). These control actions are derived from the cloud response and may include executing functions, manipulating data, or controlling UI elements within the target application (A2). The routing application (A1) may also perform additional processing operations on the cloud response before execution, such as: a) replacing security placeholders with corresponding saved credentials stored in the device memory; b) encrypting sensitive portions of the response; or c) transforming high-level commands into application-specific actions (e.g., converting “Click the mouse” into a predetermined mouse click event). This path may be available if the routing application and the target application both reside on a host laptop computer to which the routing application has full system access.

In the second processing path, when the host device does not provide access authorization for direct inter-application communication, the routing application (A1) must utilize the human interface device (HID) emulation pathway. In this case, the routing application (A1) forwards the processed cloud response to the earbud peripheral device 100 via the communication link shown as STEP 5 in FIG. 1. This transmission typically occurs over Bluetooth, and the response may be buffered by the earbud peripheral device 100 to manage data flow.

Upon receiving the cloud response, the earbud peripheral device 100 activates its HID emulation functionality (shown as emulated HID keyboard 106 in FIG. 1). The earbud peripheral device 100 reformats the structured response into HID-compliant input commands through a technical process that involves: a) parsing the structured response to identify the type of content (text, commands, or actions); b) converting text content into corresponding HID keyboard scan codes according to the USB HID Usage Tables specification; c) translating action commands into appropriate HID keyboard or mouse control codes; d) organizing these codes into properly formatted HID reports with correct report ID headers; e) implementing the required HID descriptor structures that define the input capabilities; and f) sequencing the transmission of these reports to accurately simulate human typing or input patterns, including appropriate timing intervals between keystrokes.

This reformatting transforms the cloud response into a format that emulates an HID keyboard 106 or other natively-accepted input device according to standardized accepted input specifications. The earbud peripheral device 100 contains programmable components that allow it to advertise itself as a Bluetooth keyboard, converting the cloud response into appropriate scan codes or key codes that conform to accepted input specifications. In some embodiments, the accepted input specification can be an HID Bluetooth keyboard specification for a text-based response, an HID Bluetooth mouse specification for an action-based response, both an HID Bluetooth keyboard specification and a HID Bluetooth mouse specification for a combined response, or an accepted audio input specification for an audio response. While the HID class specification established by the USB Implementers Forum describes a subset of the standard input protocols that the system can emulate in the HID emulation pathway as accepted input specifications, other input standards may be emulated depending on the target application and the modality of the cloud response. For example, an AI-generated audio response may be buffered and formatted at the peripheral device for transmission to the target application according to the accepted input specification by the Hands Free Profile or Headset Profile established by the Bluetooth SIG.

Finally, the earbud peripheral device 100 transmits the reformatted response to the target application (A2) within the mobile communication device 102 via the communication link shown as STEP 7 in FIG. 1. The transmission follows the Bluetooth HID over GATT protocol, with the peripheral device maintaining persistent bonding credentials with the host device to ensure trusted communication. The peripheral device transmits the formatted HID reports over the established Bluetooth connection's Interrupt channel, with proper report sequencing for modifier keys (such as shift, alt, or command) when needed for special characters or command combinations.

Importantly, these commands are not received by the routing application (A1), but are instead processed by the host operating system's standard input subsystem and routed directly to the currently active application, which in this case is the target application (A2). This pathway bypasses application-level security restrictions by utilizing the standardized input channels that are accessible to all applications, thereby enabling cross-application control despite operating system security boundaries.

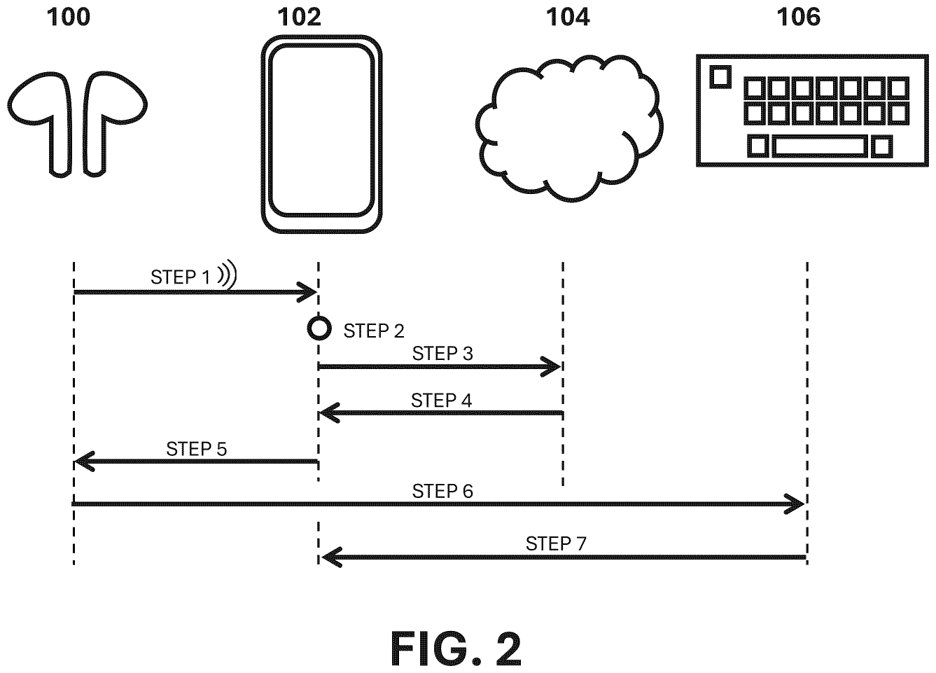

This seamless interaction between the earbud peripheral device, mobile communication device, and cloud system 104 enables powerful AI-assisted functionality across various software environments. To better illustrate the temporal sequence of these operations and information flow between system components, FIG. 2 presents a timeline diagram of the method according to an embodiment of the present technology.

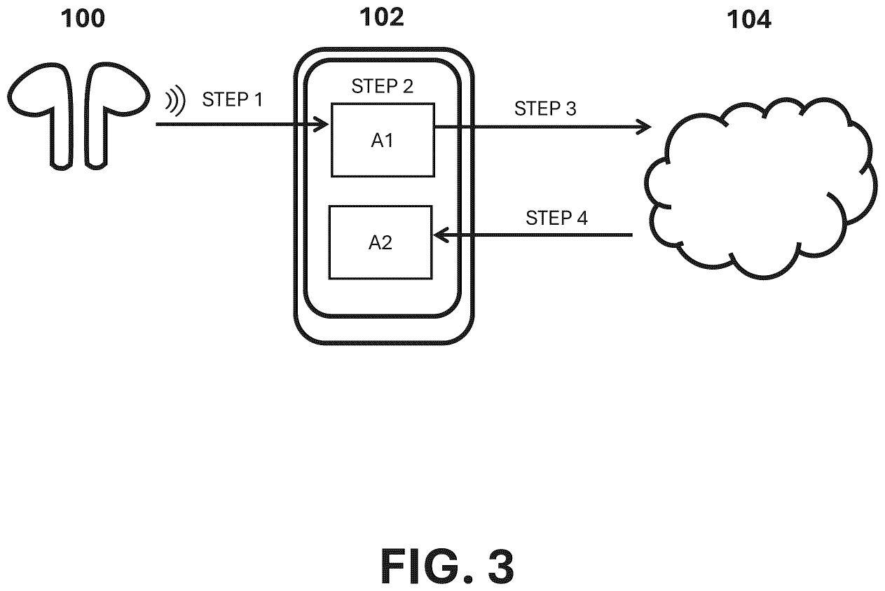

FIG. 3 is a diagram illustrating a streamlined system architecture for practicing aspects of the present technology, according to a second embodiment. In this embodiment, the mobile communication device 102 operating system provides appropriate system compatibility APIs that enable direct communication between the routing application (A1) and target application (A2), or between the cloud system 104 and target application (A2). FIG. 3 illustrates the simplified communication flow with only four essential steps:
STEP 1 transfers user input data from the earbud peripheral device 100 to the routing application (A1);
STEP 2 processes this data within routing application (A1);
STEP 3 sends the processed data to cloud system 104;
STEP 4 returns the AI-generated response directly to target application (A2).

This embodiment streamlines the architecture by eliminating steps 5-7 that involved Bluetooth keyboard emulation in the first embodiment. The simplification leverages the mobile communication device's operating system, which provides native API access between the routing application (A1) and target applications (A2). This direct communication pathway operates either through OS-level APIs or through plugin mechanisms such as iOS software keyboards that can interface with any text field in the target application. By allowing cloud responses to flow directly to the target application without peripheral device intervention, this architecture enhances efficiency while preserving the system's core functionality and delivering a more seamless user experience.

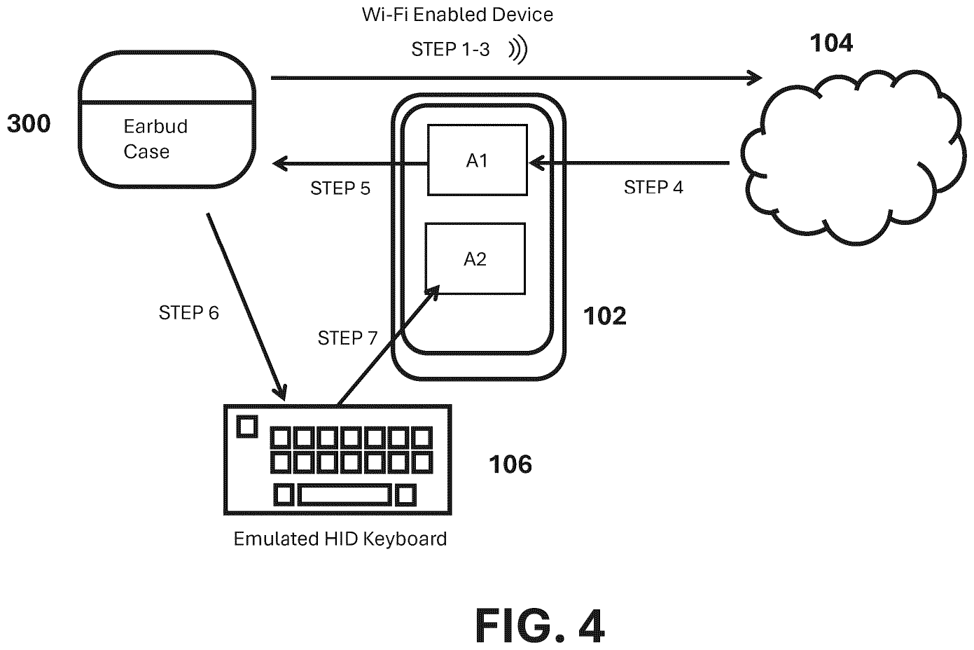

FIG. 4 is a diagram illustrating an enhanced system architecture for practicing aspects of the present technology, according to a third embodiment. This embodiment introduces a Wi-Fi enabled earbud case 300 that significantly streamlines the communication flow by enabling direct cloud connectivity. As shown in FIG. 4, the earbud case 300 combines the previously separate steps 1-3 into a single consolidated step, allowing user input to be captured, processed, and transmitted directly to cloud system 104 without requiring intermediate processing by the mobile device 102. While this front-end optimization changes the input pathway, steps 4-5 remain consistent with the previous embodiment. That is, cloud system 104 still returns its AI-generated response to the routing application (A1) on mobile device 102 via STEP 4, which then forwards this response to the earbud case 300 via STEP 5.

In this embodiment, the earbud case 300 takes on the additional responsibility of Bluetooth emulation, performing the reformatting function (STEP 6) previously handled by the earbud peripheral device in the first embodiment. The reformatted response is then transmitted by the earbud peripheral device as emulated keyboard input (STEP 7) to the target application (A2) through the emulated HID keyboard 106. This architecture leverages Wi-Fi connectivity to bypass the mobile device 102 for upstream communication while maintaining the Bluetooth keyboard emulation approach for delivering responses to applications with restricted access. The Wi-Fi enabled peripheral device may be implemented as either an earbud case, as illustrated, or as Wi-Fi enabled earbuds themselves, providing flexibility in system design while improving overall efficiency. In another embodiment, the routing application (A1) runs on a processor on the Wi-Fi enabled earbud case itself, further streamlining the communication flow by combining steps 4 and 5 as the cloud system returns the AI-generated response directly to the earbud case, while steps 6 and 7 remain unchanged.

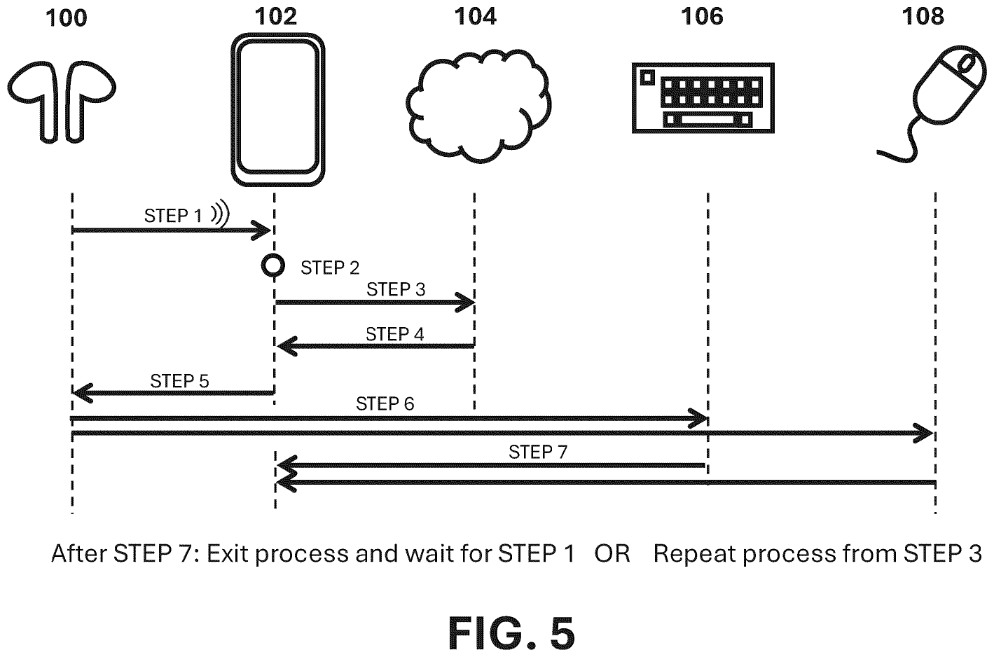

FIG. 5 is a system timing diagram illustrating the temporal flow of operations for practicing aspects of the present technology, according to a fourth embodiment. This diagram expands upon the previously described embodiments by demonstrating how input device emulation can be implemented with greater flexibility. In this embodiment, the system supports multiple types of input device emulation, including an emulated keyboard 106, as previously described, and an emulated mouse 108, which enables action-based responses beyond text entry. The timing diagram illustrates the sequence and duration of communication events between system components, highlighting that the system can activate one or both input emulations, e.g., mouse or keyboard, simultaneously or alternately as specific user interaction scenario require. This flexible emulation approach allows the system to deliver a wider range of AI-generated responses to target applications, encompassing both text inputs and cursor control actions, further enhancing the system's versatility across different software environments and use cases. Upon execution of Step 7, the system may wait for a new user command (“Exit process and wait for Step 1”) or alternately emulate a second user action in response to the same initial user command (“Repeat process from Step 3”). This feedback loop allows the system to verify that the target task has been completed without errors and take multi-step actions from a single command (for example, clicking on a webpage and then waiting for it to load before typing into its fields).

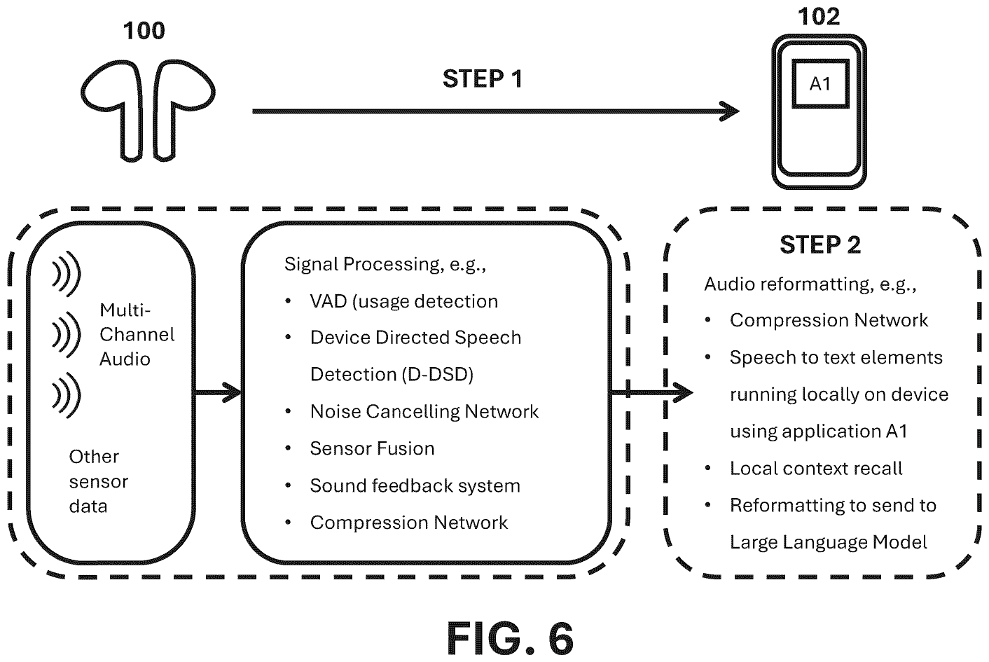

FIG. 6 provides a detailed breakdown of STEP 1 from the system architectures of FIGS. 1 and 2, illustrating the advanced signal processing pipeline within the first embodiment. FIG. 6 depicts how multichannel audio and other sensor data are captured by the earbud peripheral device 100 and subjected to multiple layers of specialized signal processing. Referring to FIG. 6, on the left side there is shown input sources: multi-channel audio from multiple microphones and other sensor data collected by the earbud. The center section details the various signal processing techniques applied to this raw input, including, but not limited to, Voice Activity Detection (VAD), Device-Directed Speech Detection (D-DSD), Noise Cancelling Network, Sensor Fusion, Sound Feedback System, and Compression Network. Following this initial processing, STEP 2 shows how the routing application (A1) on the mobile device 102 performs additional audio reformatting operations, including compression, speech-to-text conversion using local models, context retrieval, and final reformatting to prepare the data for transmission to an AI model. This comprehensive visualization presents the complex preprocessing that can occur before user input reaches cloud system 104.

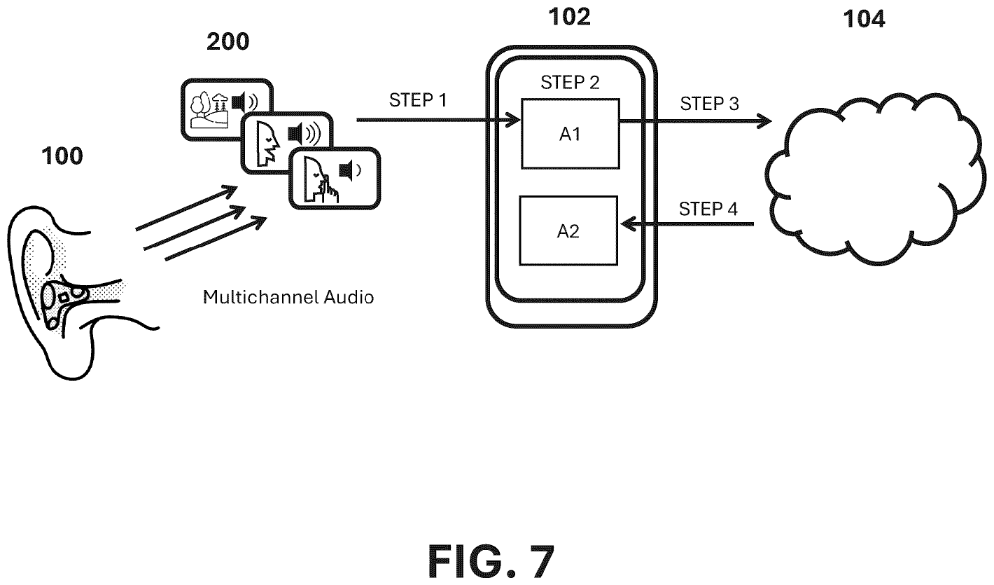

FIG. 7 illustrates an enhanced embodiment of the system architecture that expands upon the concepts presented in FIG. 3, with specific focus on advanced audio processing capabilities. In this configuration, the earbud peripheral device 100 is equipped with multiple microphones positioned both inside and outside the ear canal, enabling the capture of multichannel audio with rich spatial and acoustic properties. The diagram visualizes how these different audio sources, represented by component 200, are processed to differentiate between various types of user input and environmental sounds. Component 200 may employ one or more audio classification algorithms capable of distinguishing between multiple speech modes, such as normal speech, whispered speech, and silent speech, as well as filtering environmental noise. This multichannel audio processing occurs before transmission to the routing application (A1) on mobile device 102 via STEP 1, after which the standard communication flow continues through STEPS 2-4 as previously described. This advanced audio differentiation capability significantly enhances the system's ability to accurately capture user intent even in challenging acoustic environments, while providing users with multiple interaction modalities to suit different social contexts and privacy needs (e.g., the system may ignore user speech when the user is conversing at a normal volume with a friend, but process and respond to the user's whispered commands).

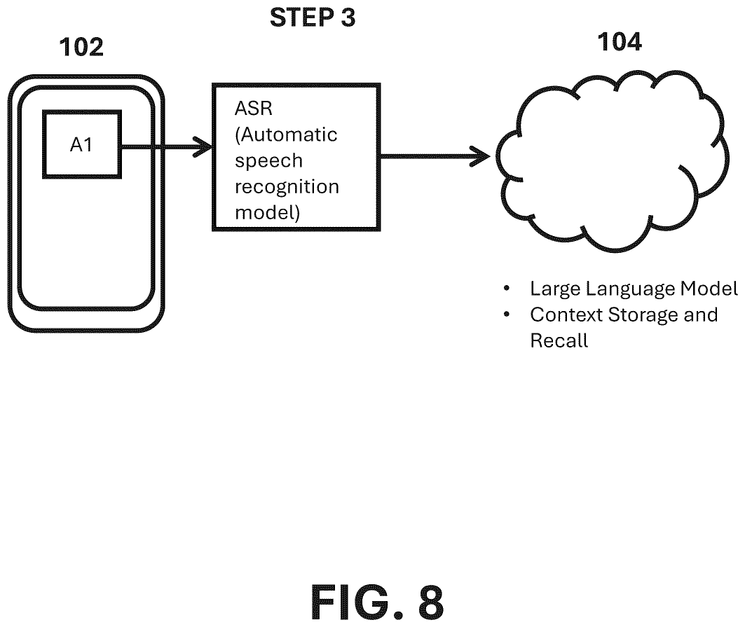

FIG. 8 illustrates a specialized implementation of STEP 3 within the system architecture previously introduced in FIG. 1. This diagram highlights an important processing enhancement where the routing application (A1) on the mobile communication device 102 routes user input through an intermediate Automatic Speech Recognition (ASR) model before transmission to cloud system 104. This architectural refinement enables more efficient bandwidth use by converting audio inputs to text locally before leveraging the cloud-based AI model. As shown in the diagram, cloud system 104 not only hosts the AI model but also provides context storage and recall capabilities that can significantly enhance response relevance. The bidirectional nature of this implementation allows context from previous interactions to be utilized by both the ASR model and the AI model, creating a feedback loop that progressively improves speech recognition accuracy and response quality. This hybrid processing approach optimizes the balance between on-device and cloud processing, reducing latency while maintaining the reasoning capabilities of the cloud-based AI system.

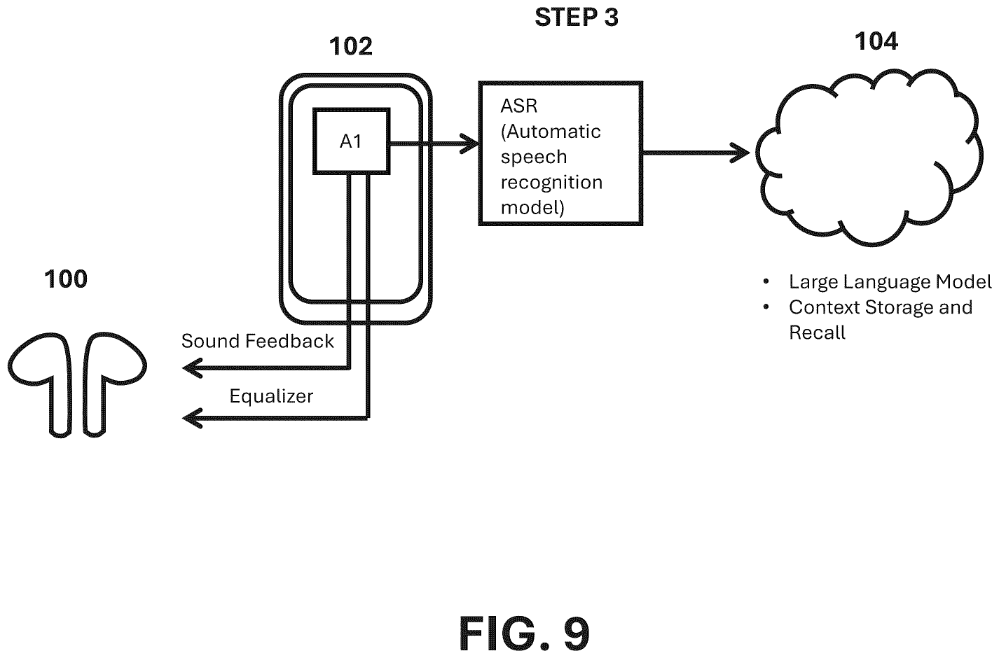

FIG. 9 expands upon the system architecture presented in FIG. 8 by introducing audio feedback mechanisms between the mobile device 102 and the earbud peripheral device 100. While maintaining the ASR model integration and cloud connectivity of the previous embodiment, this embodiment adds two critical audio enhancement pathways: (1) A Sound Feedback pathway and (2) An Equalizer pathway. These two pathways enable the routing application (A1) to dynamically adjust the audio characteristics of the earbud peripheral device 100 based on environmental conditions and user interaction patterns.

The Sound Feedback pathway allows for real-time audio processing directly on the earbud's firmware, such as amplifying whispered speech and playing it back to the user with minimal latency, providing immediate auditory confirmation of voice capture. Rather than transmitting complete audio streams back to the earbud, which would introduce significant latency, the system can efficiently transmit only the necessary parameters to tune feedback, echo cancellation, and voice activity models running locally on the earbud peripheral device 100. This approach enables audio processing while maintaining responsive performance.

The Equalizer pathway allows for dynamic adjustment of audio characteristics to optimize both input capture quality and output playback based on environmental conditions, speech modes, and user preferences. Together, these enhancements create a more responsive and personalized audio experience while preserving the advanced speech recognition and AI response capabilities of the core system architecture.

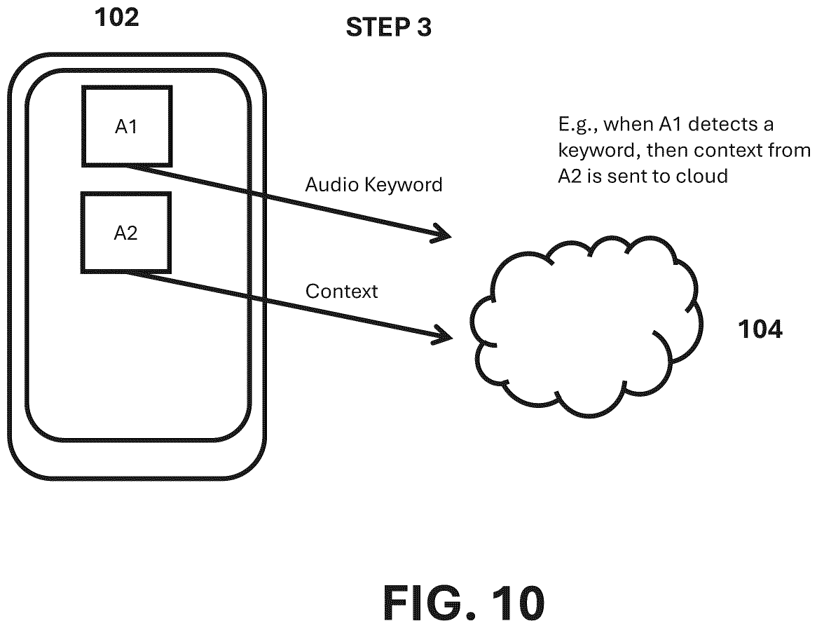

FIG. 10 illustrates an advanced collaborative application architecture that refines STEP 3 of the system previously introduced in FIG. 1. FIG. 10 illustrates a cross-application interaction model where two separate applications on the mobile communication device 102 work in concert to enhance AI query relevance. In this architecture, routing application (A1) functions as a keyword detection application that monitors for specific audio triggers or commands, while target application (A2) serves as a context provider that maintains relevant app context. When routing application (A1) detects a predetermined audio keyword, it initiates a query to cloud system 104 while simultaneously triggering target application (A1) to contribute complementary contextual information to the same query. This dual-input approach significantly enhances the relevance and accuracy of responses from the AI model by combining explicit user requests, e.g., keywords, with implicit user context. For example, if the keyword “screenshot” is detected by the routing application in the user's speech, the target application takes a screenshot and sends that context to the cloud system. FIG. 10 illustrates this synchronized data flow, showing how different data types merge into a unified query, enabling more intelligent and context-aware AI responses without requiring the user to explicitly provide background information with each interaction.

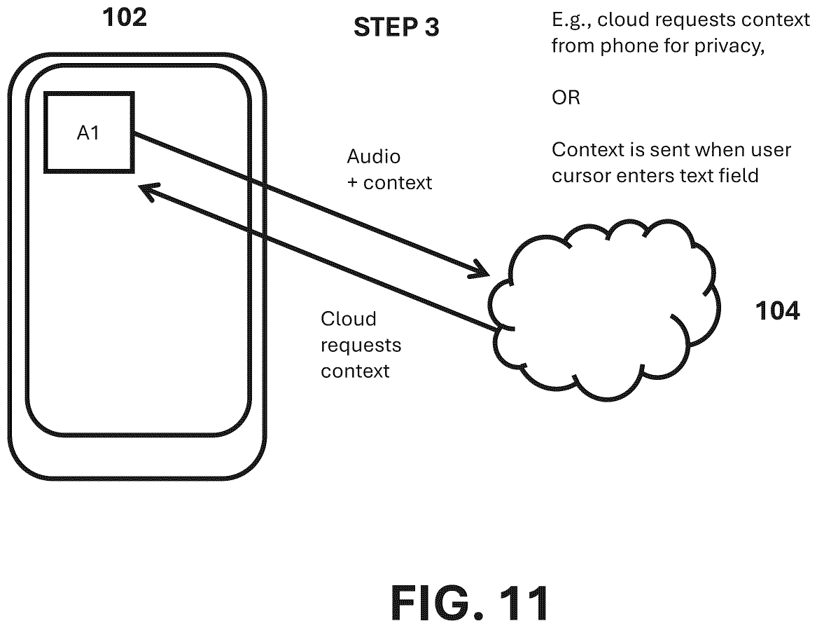

FIG. 11 illustrates a bidirectional context management implementation that enhances STEP 3 of the system architecture previously introduced in FIG. 1. This diagram demonstrates two distinct context acquisition approaches that can operate within the same system framework. In the primary flow, routing application (A1) on the mobile communication device 102 transmits both audio data and contextual information to cloud system 104 as part of a unified query. Simultaneously, the diagram illustrates a novel reverse-flow capability where cloud system 104 can proactively request additional contextual information from the mobile device 102 when needed for response generation or privacy optimization.

FIG. 11 further details an alternative trigger mechanism where contextual information can be automatically transmitted to cloud system 104 based on specific user interface interactions, such as when a user's cursor enters a text field within App 1. This event-triggered context sharing allows the system to create a closed feedback loop of action (e.g. AI mouse or keyboard manipulation) and updated state (e.g. final state of mouse position within an onscreen text field) without additional user voice input, allowing for better control of the user's experience and improved error handling by triggering the generation of corrective inputs. This event-driven context sharing also enables preemptive loading of relevant information before an explicit query is made, reducing perceived response latency. This dual-mode context acquisition framework provides significant flexibility, allowing the system to balance between privacy considerations, keeping sensitive context local until explicitly requested, and performance optimization (i.e., proactively sharing context when user intent becomes apparent through interface interactions).

This system allows two-way communication between devices and the cloud, unlike traditional one-way methods. It can both share information proactively and request it when needed. The cloud can start with basic information and ask for more details only when necessary, saving bandwidth and protecting privacy. Meanwhile, the device can predict what the user needs by watching actions like cursor movements or app switches, whether taken by the user or the system itself. By sending relevant information before it's asked for, the system responds faster. This balanced approach makes sure information is available when needed without sending unnecessary personal data.

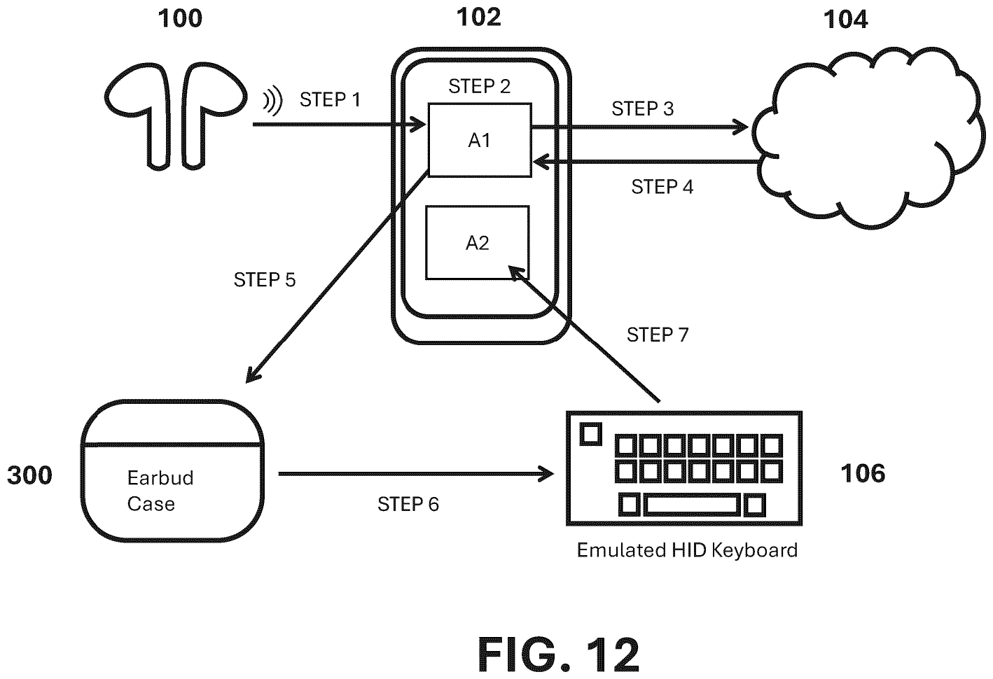

FIG. 12 illustrates an enhanced implementation of the system architecture that builds upon the framework introduced in FIG. 1, with a specific focus on optimizing STEP 5. In this refined embodiment, the routing application (A1) on the mobile communication device 102 forwards the processed text-based AI response to the earbud case 300 rather than directly to the earbud peripheral device 100. This architectural shift leverages the earbud case 300 as an intermediary processing hub that assumes responsibility for the Bluetooth HID keyboard emulation. As visualized in the diagram, after receiving the response via STEP 5, the earbud case 300 performs the necessary protocol reformatting (STEP 6) and then transmits the emulated keyboard input directly to the target application (A2) through the emulated HID keyboard 106 interface (STEP 7). This configuration takes advantage of the earbud case's potentially greater processing power and battery capacity compared to the earbuds themselves, enabling more sophisticated protocol emulation while reducing power consumption in the earbuds. The approach maintains the core system workflow through STEPS 1-4 while enhancing the delivery mechanism for AI-generated responses to applications with restricted access.

This architectural innovation represents a strategic redistribution of processing responsibilities within the peripheral ecosystem. By delegating the computationally intensive and repetitive HID emulation tasks to the earbud case rather than the space-constrained earbuds themselves, the system achieves enhanced power efficiency while maintaining seamless cross-application functionality.

The earbud case effectively serves as an intermediary computing node, bridging the gap between the cloud-based AI processing and the restrictive application environments on mobile devices. This approach elegantly circumvents the inherent limitations of direct application-to-application communication on modern mobile operating systems without compromising the user experience.

Moreover, this configuration anticipates future expansion possibilities where the earbud case might assume additional processing roles, potentially reducing latency and enhancing privacy by minimizing data transmission between system components.

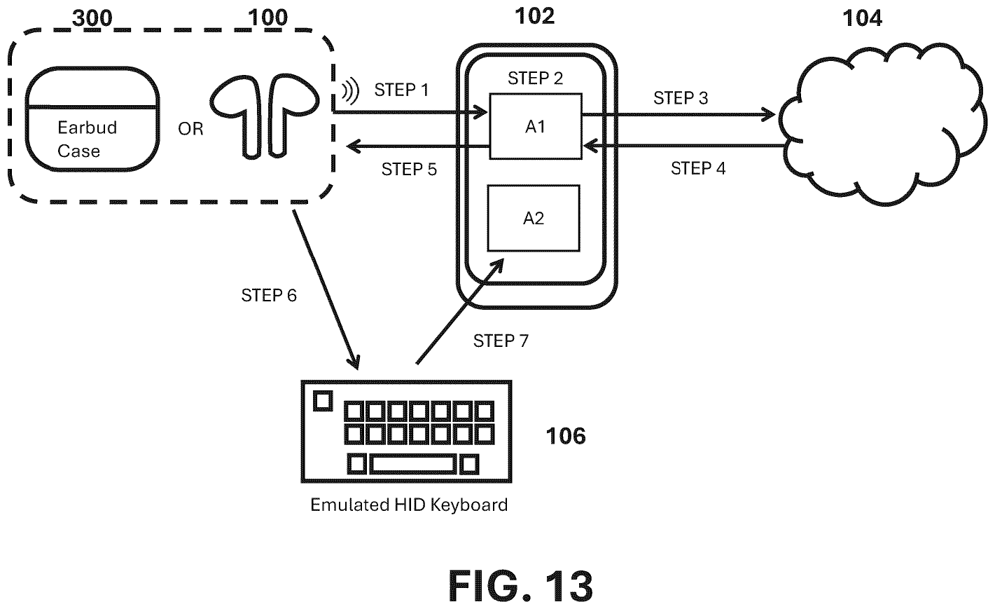

FIG. 13 is a diagram illustrating an embodiment of the system architecture where either the earbud case 300 or a set of true wireless earbud peripheral device 100 functions as the Bluetooth-enabled peripheral device for performing audio capture and wireless data transmission. The diagram shows the communication flow between the audio capture device, either earbud case or earbuds, the mobile communication device 102 hosting both the routing application (A1) and target application (A2), and cloud system 104. As depicted, the user may speak into either a microphone embedded within the true wireless earbuds or a microphone integrated into the earbud case. In either scenario, the captured audio data follows the same processing path: initially transmitted to the routing application (STEP 1), processed by the routing application (STEP 2), sent to the cloud system 104 for AI processing (STEP 3), returned to the routing application (STEP 4), forwarded back to the audio device (STEP 5), reformatted for keyboard emulation (STEP 6), and finally delivered to the target application as emulated keyboard input (STEP 7). This configuration provides flexibility in the audio capture mechanism while maintaining the core system functionality for cross-application control through voice commands.

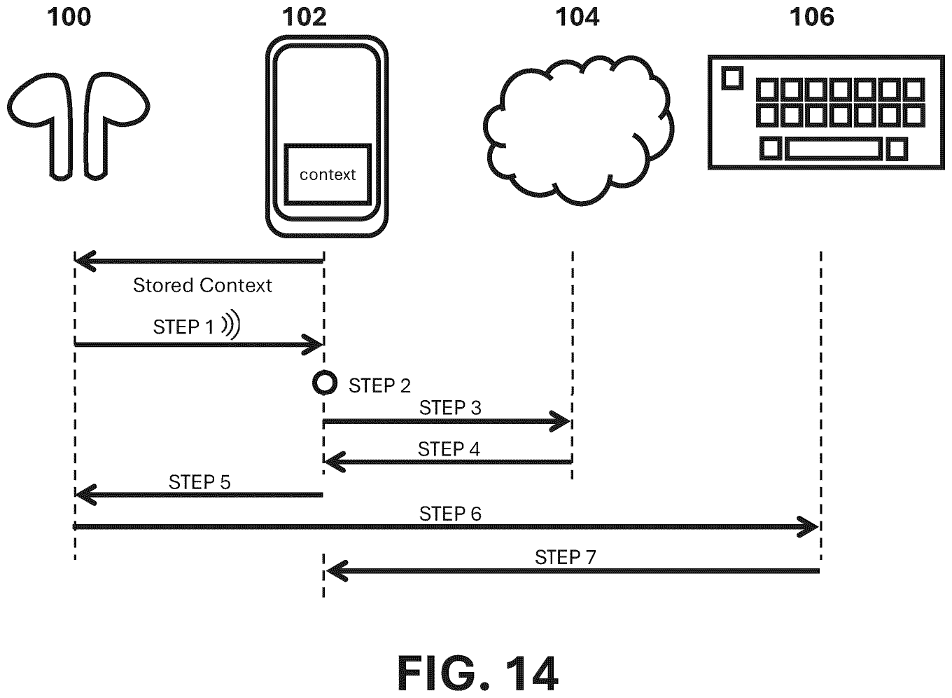

While FIG. 13 establishes the fundamental system architecture for audio capture and processing through either earbuds or an earbud case, FIG. 14 extends this framework by introducing a sophisticated bidirectional context-aware communication mechanism that enhances the system's adaptability. This evolution from basic audio routing to context-optimized processing represents a significant advancement in the system's capabilities, as detailed as follows.

FIG. 14 is a timing diagram illustrating a bidirectional context-aware communication sequence between the wireless earbud peripheral device 100, mobile device 102, cloud system 104, and emulated HID keyboard 106. The diagram shows how the mobile device 102 uses stored context to optimize the audio processing capabilities of the earbud peripheral device 100.

Before STEP 1 begins, the mobile device 102 transmits contextual parameters to the earbud peripheral device 100. This establishes an optimized framework for audio processing. The context transfer can be triggered in two ways: explicitly (when a user activates a recording function) or implicitly (based on environmental conditions detected by sensors). For example, when high ambient noise is detected, the system instructs the earbud to use enhanced signal preservation techniques like specialized noise filtration.

After this context-informed setup, the system follows its standard communication sequence. First, the earbuds capture and transmit context-optimized audio to the mobile device (STEP 1). Next, the routing application performs preliminary processing (STEP 2) before sending the data to the cloud system 104 for AI analysis (STEP 3). Cloud system 104 then returns its processed response (STEP 4), which the mobile device receives and forwards to the earbud peripheral (STEP 5). The earbud then reformats this response to match input specifications (STEP 6) before transmitting it to the target application through the emulated keyboard interface (STEP 7). This sophisticated mechanism ensures audio processing remains optimized for current user needs and environmental conditions.

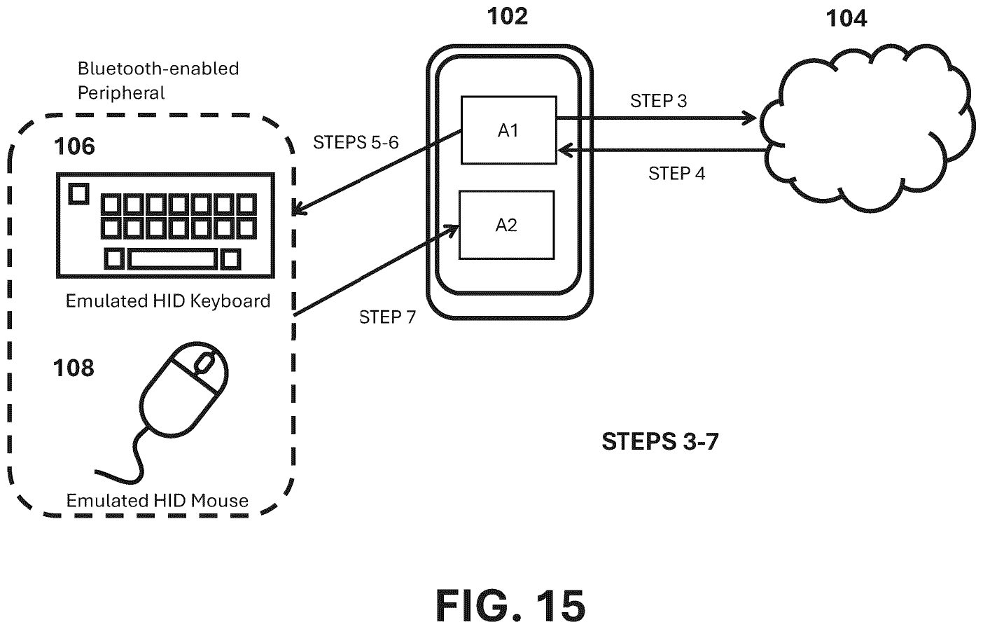

FIG. 15 illustrates a higher-level abstraction of method steps 3-7, depicting how the routing application (A1) on the mobile device 102 communicates with both cloud system 104 and a Bluetooth-enabled peripheral device (not shown). FIG. 15 highlights the dual input emulation capabilities contained within the peripheral, represented by the dashed boundary enclosing both an emulated HID keyboard 106 and an emulated HID mouse 108.

In the primary implementation shown in FIG. 15, the routing application (A1) directly commands the Bluetooth-enabled peripheral, which may be headphones, earbuds, or other Bluetooth compatible devices, to emulate either keyboard or mouse protocols for controlling the target application (A2). This process occurs autonomously without waiting for additional user input cues once initiated, creating a streamlined interaction flow between applications.

Notably, the system also supports an alternative operating mode, not explicitly depicted in FIG. 15, wherein the communication with the cloud system 104 (STEP 3) is triggered only after receiving specific user interaction. In this alternative implementation, the process begins when the user provides an input cue, such as entering text and pressing a button on a software keyboard operating within any text field on the device. This user input may be directed either to the routing application (A1) itself or to another application connected to the routing application (A1), providing flexibility in how interactions are initiated.

This dual-mode architecture enables the system to accommodate various interaction preferences and usage scenarios, balancing automated convenience with deliberate user control within the same technical framework.

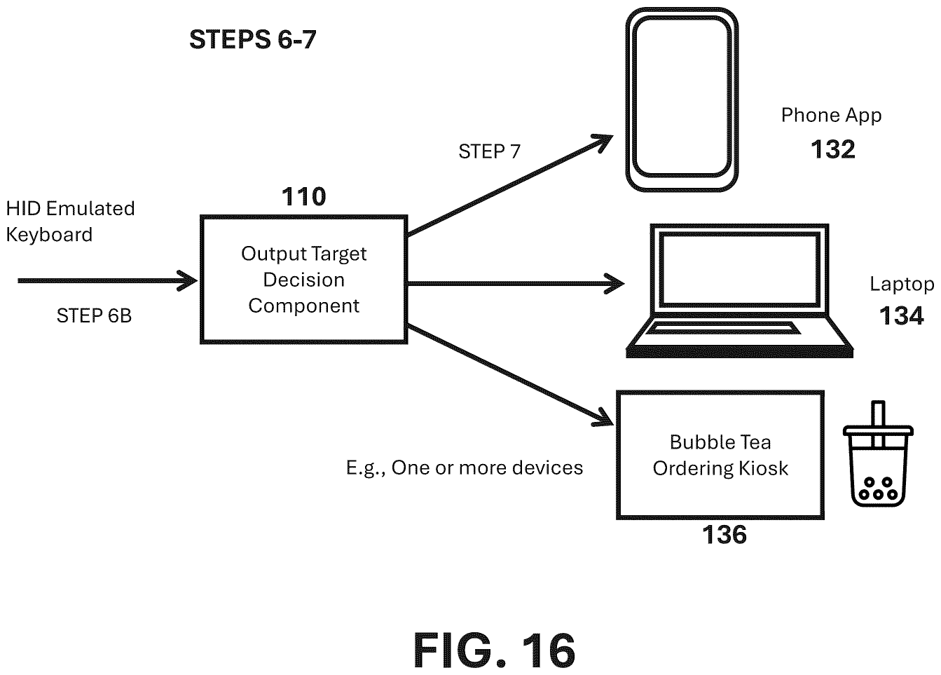

FIG. 16 illustrates a further embodiment of method STEPS 6-7 previously depicted in FIGS. 1 and 2, highlighting an intelligent routing mechanism for HID-emulated inputs across multiple target devices. FIG. 16 illustrates how the system architecture incorporates a decision-making component to determine the appropriate destination for commands generated through the voice processing pipeline.

FIG. 16 expands upon the intelligent routing mechanism introduced in method steps 6-7 of FIGS. 1 and 2. This embodiment illustrates how the system architecture supports HID-emulated inputs on a diversity of potential target devices, even when the target app is running on a different device than the routing app. More particularly, FIG. 16 illustrates how the system architecture incorporates a decision-making component to determine the appropriate destination for commands generated through the voice processing pipeline.

In this embodiment, the HID emulated keyboard 106 transmits its output packet in step 6B to a specialized routing component, namely, Output Target Decision Component 110. This specialized routing component and decision engine serves as an intelligent intermediary that analyzes the content and context of the user command to determine the most appropriate destination device for execution. The decision of the target device to which the HID command is transmitted may be based on additional context that is provided by the cloud model (e.g. the device that the user most recently interacted with) and packaged in the structured response to the routing app and the peripheral (e.g. as a JSON key-value pair providing the target device's Bluetooth device address). The decision may also be based on context that is provided by the host (e.g. the state of the target application) and packaged as a part of the processed cloud response transmitted to the peripheral (e.g. as a formatted data byte confirming the target application is ready to accept the HID command). The decision may also be based on context that is provided by the peripheral (e.g. the available Logical Link Control and Adaptation Protocol (L2CAP) channels).

As depicted in step 7, the decision engine can route the emulated keyboard input to any of several potential target devices based on various contextual factors. These destinations may include a phone application 132, a laptop computer 134, or even specialized third-party electronic devices such as a bubble tea ordering kiosk 136. The annotation “e.g., One or more devices” indicates that the system is not limited to sending the output to a single destination but can potentially broadcast the command to multiple endpoints simultaneously when appropriate.

This intelligent routing capability represents a significant advancement over conventional voice command systems, which typically operate within the confines of a single device ecosystem. By abstracting the target device selection into a dedicated decision component, the system achieves greater flexibility in executing user commands across a heterogeneous collection of computing platforms and specialized equipment, allowing seamless interaction with multiple technologies through a unified voice command interface.

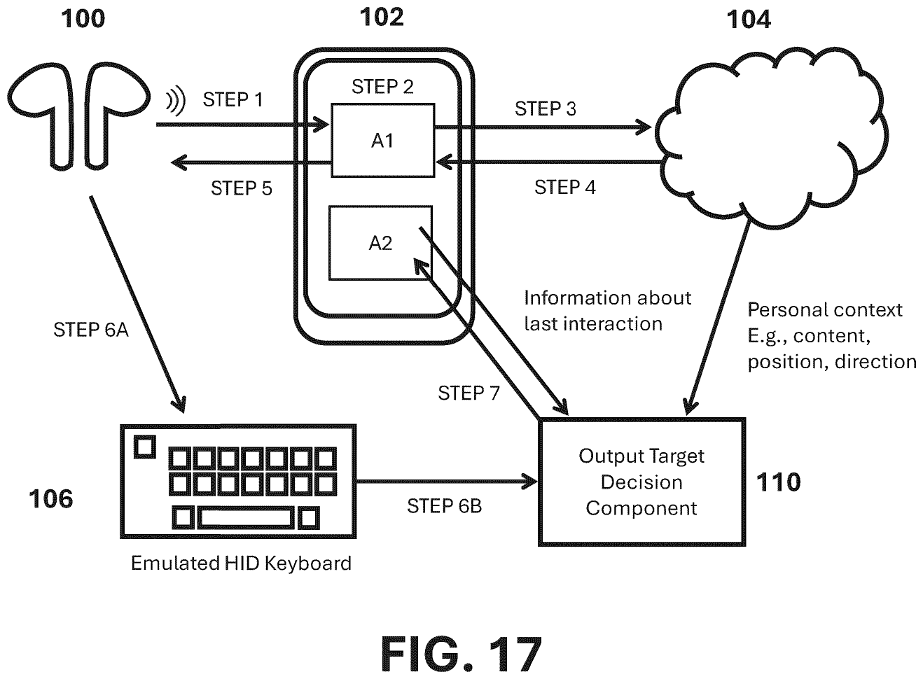

FIG. 17 illustrates a more detailed example of the intelligent routing architecture introduced in FIG. 16. While the Output Target Decision Component 110 occupies the same structural position in both FIGS. 16 and 17, its operational scope and information inputs are substantially expanded in this more detailed example. Specifically, in FIG. 16, the Output Target Decision Component 110 functions primarily as a device selector that determines which physical endpoint, phone app, laptop, or specialized equipment, should receive the command output. By contrast, in FIG. 17, this same component operates as a context-aware device selector informed by multiple data streams to optimize command routing across the user's entire device ecosystem. More particularly, the embodiment illustrated in FIG. 17 expands upon the standard system workflow (STEPS 1-5) by introducing two critical contextual information pathways that feed into the Output Target Decision Component 110. First, “Information about last interaction” flows directly from the target application (a2) on the mobile device 102 to the decision engine (shown via STEP 7). Second, “Personal context” data, e.g., content, position, direction, flows from cloud system 104 to further inform the routing decision.

In this context-enriched architecture, the Output Target Decision Component 110 makes intelligent determinations about command destination based on a holistic analysis of the user's technology environment. For example, when a user is simultaneously engaged with applications across multiple devices, such as a target application on their phone and a non-target application on a computer connected to the input device 100, the Output Target Decision Component 110 can prioritize the destination based on recency of interaction.

The system tracks which device the user interacted with most recently and routes voice commands accordingly. For example, if the user was just typing on their phone before speaking a command, the system will prioritize routing the command to the phone application over alternative connected devices, even if all devices are capable of receiving the command.

Beyond recency of interaction, the system can make routing decisions based on semantic matching between the voice command content and UI elements available on potential target devices. When such matching is required, the decision process may occur earlier in the workflow, potentially within the routing application (A1) or even in cloud system 104, before the command reaches the HID output stage.

The system analyzes the content of user requests to determine the most appropriate destination devices. For example, if a user issues the command “order my usual bubble tea,” the system recognizes this command relates to the bubble tea app and routes it accordingly, even if the user was more recently interacting with a word processor or email client.

The system also supports flexible delivery methods for output commands. While most scenarios involve targeted transmission to a specific device, the system can alternatively broadcast commands to multiple connected devices simultaneously. This capability allows for redundant command execution or distributed processing across the user's technology ecosystem.

This approach represents a significant advancement from simple device routing to contextually aware decision making. The result is a cross-device voice control system that enables more intuitive and adaptive command execution.

The system aligns with users' actual interaction patterns and facilitates seamless interaction across diverse technologies through a unified command interface that adapts intelligently to the user's behavior patterns and environmental context.

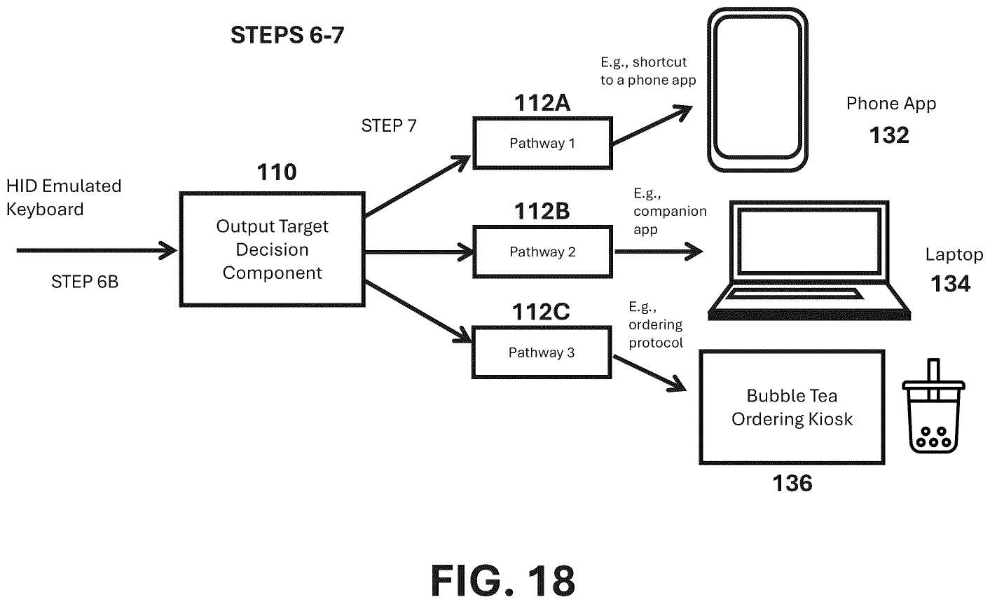

FIG. 18 illustrates a further embodiment of an enhanced command routing system with dynamic transformation capabilities for cross-device compatibility. This embodiment significantly extends method steps 6-7 previously introduced in FIG. 16, highlighting a sophisticated output adaptation mechanism that enhances cross-device compatibility. In this embodiment, the system determines the appropriate destination for commands and in addition, dynamically reformats those commands to match the specific input requirements of each target device. Examples include:

Screen Size adaptation: if a user decides to interact with a particular device with a larger screen, the HID mouse motion coordinates are rescaled to match the target display dimensions.

Custom command mapping: When performing an action on a device configured with user-specific shortcuts, the HID output is remapped to the appropriate keyboard combination for that particular device.

Referring to FIG. 18, after the Output Target Decision Component 110 determines the appropriate destination for a command (following STEP 6B from the HID Emulated Keyboard) the system introduces an intermediate transformation layer represented by the transformation pathway modules 112A-C. Each potential destination path has its own dedicated transformation module that reconfigures the command structure according to the protocols and interface requirements imposed by the destination device.

### Mobile Device Transformation Pathway (112A)

For the phone app transformation pathway module 112A, the output may be formatted as a specialized shortcut command that triggers specific application functions rather than simple text input. For example, if a phone app is specified as the target device and the intended command is the execution of a particular function (e.g. take a screenshot), the pathway may cause the format of the output packet to be configured as a particular HID keyboard hotkey command that triggers a system-level shortcut known to perform the predefined action within the application (e.g. the HID key combination command+s).

### Computer System Transformation Pathway (112B)

For the laptop transformation pathway module 112B, the transformation might involve compatibility adjustments for desktop operating systems, such as Windows or macOS, potentially leveraging companion applications that extend functionality across platforms. For example, commands might be formatted to work with a laptop's 116 companion app as noted in FIG. 18. This could include adapting the command structure to work with specific software environments or adjusting an HID keyboard command to match a different language's keyboard layout based on user preferences.

### Specialized Device Transformation Pathway (112C)

For specialized electronic devices transformation pathway module 112C, such as the Bubble Tea Ordering Kiosk 118, the transformation becomes even more specialized, converting general commands into device-specific ordering protocols that comply with proprietary input formats. This might involve restructuring the command syntax to match API requirements or encoding the user's preferences in a format natively recognized by the kiosk's ordering system.

This adaptive formatting capability represents a significant advancement over conventional command routing systems, which typically require commands to be pre-formatted for specific destinations. By implementing dynamic transformation at the routing layer, the system enables truly universal command interpretation across heterogeneous device ecosystems, removing compatibility barriers and allowing users to interact naturally without needing to understand or adjust for the underlying technical requirements of each target device.

The system's ability to dynamically adjust output formats extends to numerous scenarios not explicitly shown in FIG. 18.

### Localized Input Support:

If a phone app 114 which enables typing with a French keyboard is specified, the format of the output packet may be reconfigured as an HID keyboard with key codes corresponding to a French keyboard layout.

### Protocol Adaptation:

Inputs and commands might be transformed into specialized data transmission formats for various device types: smart home devices, media players, or industrial equipment depending on the target ecosystem and input data type—for example HID, Matter Protocol, Zigbee, WebHID, Hands Free Profile, or Headset Profile.

This input emulation capability allows the system to request and reformat the structured AI response in order to enable input to a diversity of target devices using their natively-supported protocols (e.g. AI text input to an email app, AI-directed mouse input to a web browser, AI-generated audio input to a phone calling system, or AI-generated commands to a smart home control system), without requiring full system access to the target device's operating system or API access to the target application.

In one embodiment, the Output Target Decision Component 110 may be positioned after the command is sent to the peripheral device, thereby enabling dynamic adaptation based on the connectivity state of the peripheral itself to various nearby target devices. Positioning the Output Target Decision Component 110 after the command is sent to the peripheral device allows for dynamic adaptation based on the connectivity state of the peripheral itself to various nearby targets. This dynamic adaptation capability distinguishes this approach from embodiments where output routing and reformatting to match the target application is handled within the routing application in Step 2 or the contextual AI system in Step 4.

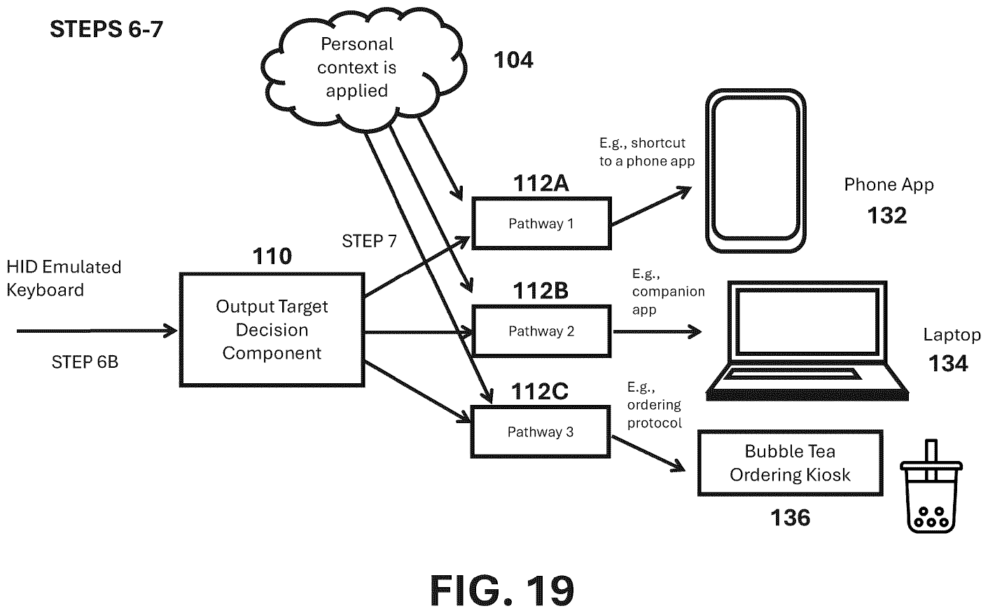

FIG. 19 illustrates an enhanced embodiment of the system architecture previously introduced in FIG. 18, specifically highlighting the integration of personalized contextual information into the output adaptation process. This embodiment expands upon method steps 6-7 by demonstrating how cloud-stored personal context data actively shapes both routing decisions and command formatting.

As depicted in FIG. 19, cloud system 104 containing the user's personal context information now has direct influence pathways to both the Output Target Decision Component 110 and each of the transformation pathway modules 112C. This dual-influence architecture enables two distinct levels of personalization in the command execution process.

First, personal context informs the initial routing decision, potentially prioritizing certain devices based on the user's established preferences, usage patterns, or situational factors. For example, if cloud-stored data indicates that the user typically orders bubble tea while commuting, commands related to beverage ordering might be preferentially routed to the Bubble Tea Ordering Kiosk during typical commuting hours.

Second, and more significantly, the personal context data actively shapes how commands are formatted once the destination is determined. This allows for deeply personalized interaction experiences tailored to individual preferences across different target devices. For the phone app pathway, personal context might influence which shortcuts are triggered or how information is presented, based on accessibility preferences. For the laptop pathway, it could determine language settings, keyboard layouts, or software-specific configurations that match the user's established working patterns. For specialized devices like the Bubble Tea Ordering Kiosk, it might automatically incorporate the user's favorite order options, payment preferences, or customizations without requiring explicit specification in each command.

This contextual adaptation mechanism creates a significantly more intuitive user experience by leveraging historical behavior patterns and preferences to anticipate needs. Rather than applying generic transformation rules, the system can dynamically adjust command formatting based on rich personal profiles maintained in cloud system 104, ensuring that interactions across all devices maintain consistency with the user's established preferences and habits regardless of which physical endpoint receives the command.

The following examples illustrate how personal context data actively transforms user interactions across diverse digital environments by precisely tailoring command formats to individual preferences, accessibility needs, and established habits. These concrete applications reveal how context-aware systems create deeply personalized experiences that extend far beyond basic command routing:

When considering the phone app transformation pathway module 112A with personal context, multiple implementations showcase its adaptability.

As a first example, a visually impaired user's context data automatically activates larger text display and voice readout functionality when sending commands to their phone.

As a second example, a user who monitors their health has commands intelligently routed to prominently display heart rate data within their fitness app dashboard.

As a third example, a multilingual professional's phone seamlessly switches between displaying command responses in Spanish during morning hours and English during work hours, reflecting their established language usage patterns.

For the laptop transformation pathway module 112B with personal context, several sophisticated customizations emerge. As a first example, a graphic designer's commands to their laptop instantly open files in their preferred design software with their custom-configured toolbar layout and color settings. As a second example, a programmer's commands automatically launch their IDE with their specific dark theme and personalized keyboard shortcut configuration. As a third example, a business analyst's spreadsheet commands immediately implement their preferred data visualization formats and calculation templates without requiring manual adjustments.

For the specialized Bubble Tea Ordering Kiosk transformation pathway module 112C with personal context, numerous personalized features enhance the transaction experience. As a first example, the system immediately recognizes the user and pre-populates “Large Taro Milk Tea, 30% sugar, less ice” based on their previous order history. As a second example, payment preferences automatically default to the user's preferred mobile payment method without prompting. As a third example, loyalty rewards are silently applied without the user needing to mention their membership status. As a fourth example, dietary restrictions stored in the user's profile proactively filter out menu options containing allergens before they're even displayed.

In each scenario, personal context data doesn't merely determine command destinations but fundamentally reshapes how those commands are formatted, prioritized, and presented creating truly personalized digital experiences that anticipate and accommodate user needs.

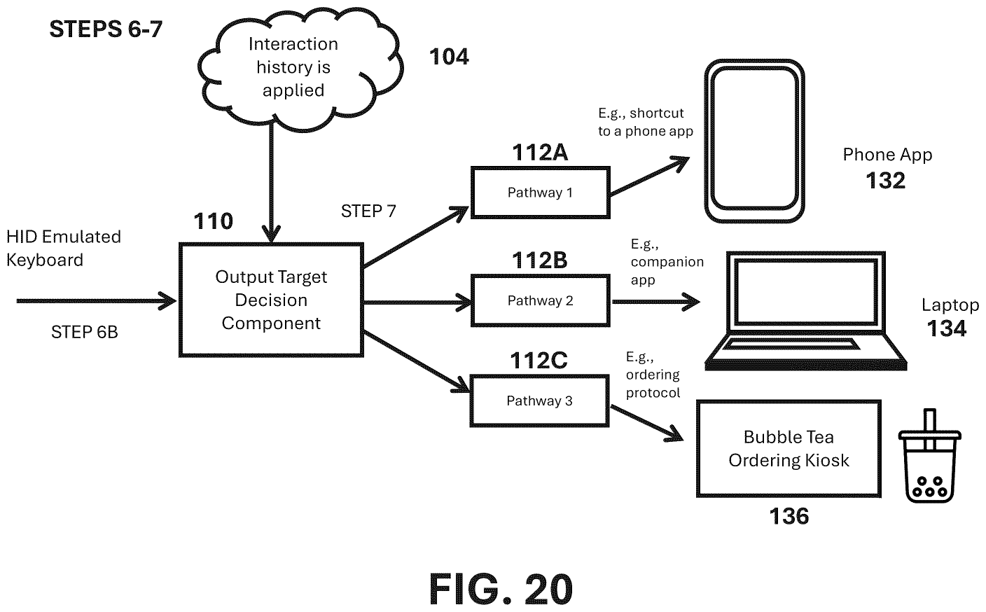

FIG. 20 illustrates a further embodiment of the system architecture of FIG. 18, with respect to method steps 6-7, highlighting the integration of cloud-based interaction history into the intelligent routing decision process. In this embodiment, interaction history stored in cloud system 104 is actively leveraged to inform the Output Target Decision Component 110 regarding the optimal destination for command execution. This historical context creates a learning system that progressively refines its routing decisions based on established user patterns and explicit preferences.

Cloud system 104 maintains a comprehensive record of previous user interactions with various destination devices. This historical data encompasses both explicit user preferences and implicit behavioral patterns. Together, they create a sophisticated decision framework that goes beyond simple device selection. For example, when a user consistently directs beverage-related queries to the Bubble Tea Ordering Kiosk, the system learns this association. It can then automatically route similar future commands to this destination without requiring explicit specification each time.

The system implements a continuous learning mechanism that updates interaction histories and preference models after each user engagement. This adaptive approach is particularly valuable for users with specialized needs or usage patterns. Consider a user with mobility limitations, such as a wheelchair user. This person might frequently target devices that are physically distant from their typical position. The system can recognize when the user redirects commands and identify these correction patterns. It then updates its routing model accordingly. After detecting these patterns, future outputs are automatically sent to the appropriate device without requiring additional intervention. This creates a personalized experience that anticipates the user's intended targets based on established behaviors.

As illustrated in FIG. 20, once the Output Target Decision Component 110 determines the appropriate destination based on this historical context, the command undergoes device-specific transformation through one of three destination-specific transformation pathway modules 112A-C. Each transformation pathway is optimized for its particular destination. That is, the Phone App pathway module 112A formats commands as app-specific shortcuts, the Laptop pathway module 112B implements companion app protocols, and the Bubble Tea Ordering Kiosk pathway module 112C utilizes specialized ordering protocols. This combination of historically informed routing decisions and destination-specific formatting enables a deeply personalized cross-device experience that continuously improves through ongoing interaction.

The cloud-based architecture of this historical context system ensures consistent performance across the user's entire device ecosystem, maintaining preference continuity even when interacting with new or temporarily used devices. By centralizing the interaction history in cloud system 104 rather than on individual devices, the system can provide consistent routing decisions regardless of which input mechanism the user employs to initiate commands, creating a truly unified cross-device control experience that adapts to evolving user behaviors and preferences.

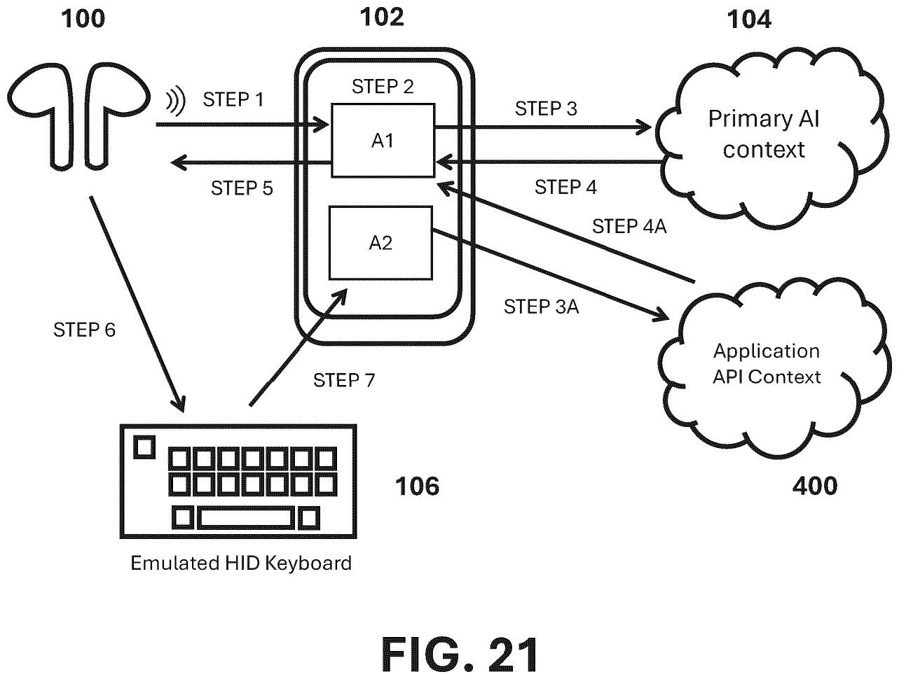

FIG. 21 illustrates an embodiment of a system architecture featuring multiple pathways for creating and integrating personal AI Model context. This embodiment establishes bidirectional information flows between local applications and cloud services to improve context-aware voice command processing, enhancing the accuracy and relevance of AI-generated responses across devices. More particularly, the system enables personal AI context creation through two distinct but complementary mechanisms: (1) routing application context and (2) target application context. These complementary context mechanisms function through distinct data pathways, each contributing unique information that enhances voice command processing, described as follows.

As illustrated in FIG. 21, the first context creation pathway, corresponding to the routing application context, originates from the API associated with the routing application (A1) on the mobile device 102. This application serves as the primary interface between the user's voice commands, captured by the earbud peripheral device 100, and the cloud-based processing systems. The routing application (A1) generates and collects relevant contextual information from the mobile device environment, including device state, user preferences stored on the device, historical interaction patterns maintained by the application, and environmental data collected by the host device sensors. In STEP 3, the routing application (A1) transmits both the processed user command and this accumulated contextual information to cloud system 104. The contextual information may include, but is not limited to, the aforementioned types of data, as various embodiments may utilize additional forms of contextual information suitable for enhancing voice command processing.

Similarly, as depicted in FIG. 21, the second context creation pathway, corresponding to the target application context, originates from the API of the target application (A2), which the user intends to control through voice commands. In STEP 3A, the target application (A2) independently transmits application-specific contextual information to a dedicated Application API Context cloud service 400. The target application (A2) collects and provides contextual information specific to its operational environment, including the current state of the application, active content being displayed, available functionality, and user-specific configurations within that application environment. For example, if the target application (A2) is an email client, this contextual information may include the content of the currently displayed email, recipient information, attached files, and recent email threads. As a further example, if the target application (A2) is a word processor, the contextual information may include the document's content, formatting styles, a screenshot of the application showing the cursor position, and active editing mode. This application-specific contextual information may include, but is not limited to, the aforementioned types of data, as various embodiments may utilize additional forms of application-specific context suitable for enhancing voice command relevance to the particular target application.

The system then orchestrates a two-part response generation process. At STEP 4, the AI-generated response from the primary cloud system 104 is delivered back to the routing application (A1), incorporating insights derived from the routing application's contextual information. This represents the first component of the complete response. Simultaneously, at STEP 4A, the Application API Context cloud 400 returns application-specific contextual information to the routing application (A1), which constitutes the second component of the response. This application-specific information provides targeted insights that enhance the relevance of the final combined response.

In this embodiment, the routing application (A1) functions as an integration hub, combining the general AI response received in STEP 4 with the application-specific contextual information received in STEP 4A. This combination creates a comprehensive response that is both contextually accurate and specifically tailored to the target application's capabilities and current state.

Since the routing application lacks access to control the target application, the integrated response is then transmitted to the earbud peripheral device 100 in STEP 5, where it undergoes reformatting in STEP 6 to comply with HID keyboard protocol specifications. Finally, in STEP 7, the reformatted command is transmitted to the target application (A2) through the emulated HID keyboard 106, appearing as standard keyboard input despite originating from a voice command processed through multiple layers of context.

This dual-context architecture enables more effective interactions than conventional voice command systems. For example, when a user requests “Send an email to the team about tomorrow's meeting,” the system can simultaneously leverage personal context from the routing application (A1) (e.g., user's team contacts, communication preferences) and target application (A2) context (e.g., email client state, available templates, recent conversations) to generate a relevant response that incorporates information across both context sources, while ensuring target application context data never leaves the user's local devices.

The dual-context architecture employs several key technical mechanisms to ensure proper operation. The system structures context data with appropriate identifiers that distinguish between routing application and target application sources, enabling accurate processing during transmission. When integrating information from both context sources, the system implements a straightforward priority mechanism that favors explicit user inputs over background context when conflicts occur. For security, the dual-context exchanges utilize the same encryption and placeholder substitution techniques described above, ensuring sensitive application context remains protected throughout the transmission process. This implementation maintains the integrity of context data while optimizing the exchange between applications.

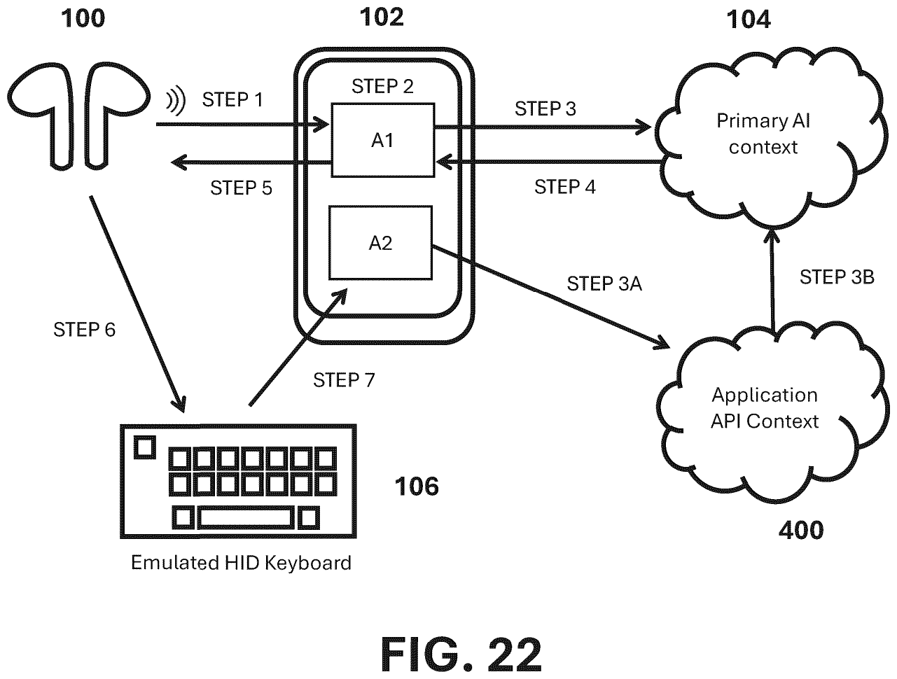

FIG. 22 illustrates an enhanced version of the embodiment shown in FIG. 21, featuring direct cloud-to-cloud communication. While steps 3 and 3A continue to send context from the routing application (A1) and target application (A2) to their respective cloud systems as in the previous embodiment, this embodiment introduces a critical new step 3B.

The key innovation in this embodiment is the direct cloud-to-cloud information exchange represented by STEP 3B. This step establishes a communication channel between the Application API Context cloud 400 and the primary AI context cloud 104, enabling more efficient handling of contextual data. This architecture allows the Application API Context cloud 400 to transmit relevant application-specific information directly to the primary AI context cloud 104, enhancing the AI model with additional cloud-stored information that may not be present on the mobile device itself. This process is especially relevant when the target app provides a cloud-based API to access its contextual data.

For example, when a user requests an AI to compose an email reply, the process works as follows: In STEP 3, the user's voice command and local context from the routing application are sent to the cloud 104. In STEP 3A, the email application sends the currently active email content and metadata to the Application API Context cloud 400. In STEP 3B, the Application API Context cloud 400 directly forwards both the currently displayed email content and additional cloud-stored data (such as the history of previous correspondence with the recipient) to the primary AI context cloud 104. This supplementary context is integrated with the initial context from STEP 3, creating a comprehensive foundation for generating an accurate AI response.

After processing the combined context information, the AI-generated response from the primary cloud system 104 is delivered back to the routing application (A1) in STEP 4. Unlike the embodiment in FIG. 21, which returns two separate response components, this architecture consolidates all contextual intelligence into a single, comprehensive response. This approach reduces the processing burden on the routing application (A1) while potentially improving response relevance through more thorough context integration at the cloud level.

The integrated response is then transmitted to the earbud peripheral device 100 in STEP 5, where it undergoes reformatting in STEP 6 to comply with HID keyboard protocol specifications. Finally, in STEP 7, the reformatted command is transmitted to the target application (A2) through the emulated HID keyboard 106, appearing as standard keyboard input despite originating from a voice command processed through multiple layers of context enhancement.

This cloud-to-cloud architecture enables more efficient handling of complex contextual relationships while minimizing data transmission to and from the mobile device 102. By allowing direct communication between specialized cloud systems, the embodiment facilitates a more comprehensive analysis of user patterns, preferences, and application-specific requirements before generating the final AI response.

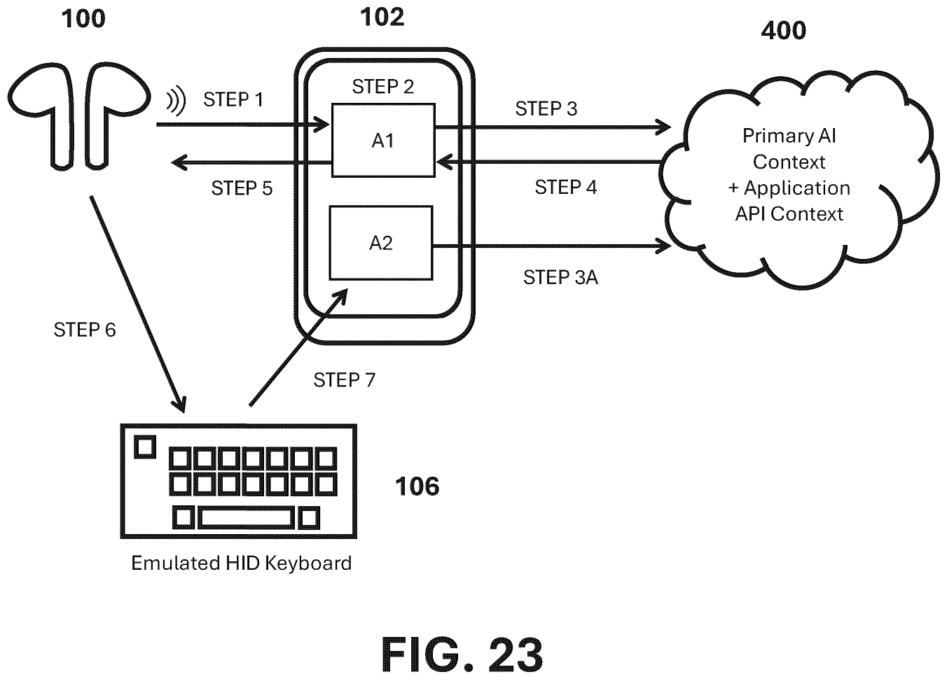

FIG. 23 illustrates an alternative implementation of the system architectures previously presented in FIGS. 21 and 22, featuring a unified cloud processing approach. This embodiment maintains the core functionality of the previous implementations while streamlining the cloud infrastructure through consolidation. As described in the previous embodiments, STEP 3 and STEP 3A send context from the routing application (A1) and target application (A2) to the cloud. However, unlike the separate cloud systems 102, 104 shown in FIGS. 21 and 22, this embodiment directs both context streams to a single integrated cloud environment 400, labeled “Primary AI Context+Application API Context,” where processing occurs within a unified pipeline before returning a consolidated result to the routing application (A1) at STEP 4. This approach produces an inherently integrated response without requiring the additional processing steps needed in FIG. 21 to combine separate responses or the inter-cloud communication required in FIG. 22 to coordinate context between separate cloud systems.

As previously described in connection with FIGS. 21 and 22, the first context creation pathway originates from the API associated with the routing application (A1) on the mobile device 102. This pathway functions similarly in the present embodiment, where in STEP 3, the routing application (A1) transmits the processed user command and relevant contextual information to the unified cloud system 400. The nature and types of contextual information remain consistent with the descriptions provided for the previous FIGs., including device state, user preferences, historical interaction patterns, and environmental data from the host device sensors.

Similarly, the second context creation pathway originates from the target application (A2), which the user intends to control through voice commands. This pathway also functions similarly in the present embodiment, where in STEP 3A, the target application (A2) independently transmits application-specific contextual information to the same unified cloud system 400. The types of application-specific contextual information remain consistent with the previous descriptions, including application state, active content, available functionality, and user-specific configurations.

The key innovation in this embodiment is the consolidation of cloud processing resources into a single integrated environment. This unified approach eliminates the need for inter-cloud communication steps, such as STEP 3B in FIG. 22. It processes all contextual information within what we call a “common framework.” This framework is a unified computational environment with shared memory, processing resources, and data models. It provides direct access to all contextual information without requiring data transformation or transmission between separate systems.

The unified computational environment facilitates two representative implementations that demonstrate its technical advantages: First, when processing a user request to “Send an email to my team about the project deadline,” the consolidated cloud system simultaneously accesses both team contact list information (typically stored in routing application context) and project deadline parameters (typically maintained in target application context) within a single memory space. Second, when processing a user request to “Add a reminder about my upcoming flight,” the system performs unified access to both calendar availability data and notification preference parameters without requiring inter-system data exchange protocols. These implementations demonstrate the architectural efficiency gained through computational consolidation.

The integrated cloud system 400 combines and processes both types of context internally, allowing for seamless integration. It eliminates the need for explicit communication pathways between separate cloud systems 102, 104. In other words, the integrated approach removes the need to coordinate, synchronize, and exchange data between separate specialized cloud environments. This reduces potential points of failure and communication overhead.

This consolidated cloud architecture provides several technical advantages. First, it reduces latency by eliminating the additional communication steps required in multi-cloud implementations. When a user employs the input device to request an AI model to perform an action, such as composing an email reply, both the user's voice command (from STEP 3) and the application context (from STEP 3A) are processed within the same computational environment. This unified processing allows for more efficient context matching, as all relevant information is immediately available within a shared memory space rather than requiring serialization, transmission, and deserialization between separate systems.

The previous embodiments faced several limitations due to their distributed architectures. In the FIG. 21 embodiment, context information remained isolated in separate cloud systems until reaching the mobile device. This required the routing application to perform additional processing to integrate different responses. Such an approach increased the computational burden on the mobile device 102 and created potential synchronization challenges.

The FIG. 22 embodiment addressed some of these limitations through inter-cloud communication. However, it still relied on explicit data transfer protocols between separate systems. This introduced additional complexity, compatibility issues, and synchronization overhead.

By contrast, the consolidated architecture in the present embodiment eliminates these structural limitations. It fundamentally redesigns the cloud infrastructure to enable native, seamless context sharing. This design overcomes the fragmentation problems present in the earlier approaches while delivering more efficient processing of contextual information.

After the unified cloud system 400 processes the combined context information, an AI-generated response is created and delivered back to the routing application (A1) at STEP 4. Unlike the embodiment in FIG. 21, which returns two separate response components, or the embodiment in FIG. 22, which requires inter-cloud communication before response generation, this architecture inherently produces a single, comprehensive response by processing all contextual information within the unified environment. This approach further reduces the processing burden on the routing application (A1) as it eliminates the need for local response integration.

The integrated response is then transmitted to the earbud peripheral device 100 in STEP 5, where it undergoes reformatting in STEP 6 to comply with HID keyboard protocol specifications. Finally, in STEP 7, the reformatted command is transmitted to the target application (A2) through the emulated HID keyboard 106, appearing as standard keyboard input despite originating from a voice command processed through the unified context-aware cloud system 104.

The embodiment illustrated in FIG. 21 had limitations from its segregated cloud systems. It forced the routing application to perform extra processing on the mobile device to combine separate responses. This increased computational burden and created synchronization challenges.

The embodiment illustrated in FIG. 22 partially solved the issues of the embodiment of FIG. 21 by using intercloud communication. However, it still required explicit data transfer protocols between systems, which introduced complexity and compatibility concerns.

The consolidated architecture of the present embodiment fundamentally redesigns the cloud infrastructure. It eliminates these structural limitations by enabling native context sharing in a single environment. This approach addresses core architectural constraints of the previous embodiments.

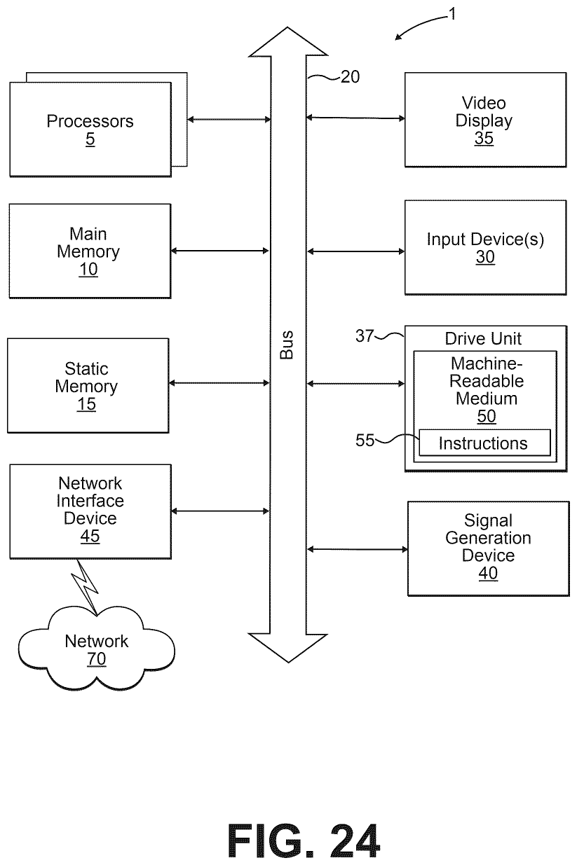

FIG. 24 is a diagrammatic representation of an example machine in the form of a system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be an Internet-of-Things device or system, a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The system 1 includes a processor or multiple processor(s) 5 (e.g., a central processing unit (CPU), a graphics processing unit (GPU), or both), and a main memory 10 and static memory 15, which communicate with each other via a bus 20. The system 1 may further include a video display 35 (e.g., a liquid crystal display (LCD)). The system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. Instructions 55 may also reside, completely or at least partially, within the main memory 10 and/or within the processor(s) 5 during execution thereof by the system 1. The main memory 10 and the processor(s) 5 may also constitute machine-readable media. Instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

The components provided in the system 1 of FIG. 24 are those typically found in systems that may be suitable for use with embodiments of the present technology and are intended to represent a broad category of such computer components that are well known in the art. Thus, the system 1 can be an Internet-of-Things device or system, a personal computer (PC), handheld system, telephone, mobile system, workstation, tablet, phablet, mobile phone, server, minicomputer, mainframe computer, wearable, or any other system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN, and other suitable operating systems

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology.

Those skilled in the art are familiar with instructions, processor(s), and storage media. In some embodiments, system 1 may be implemented as a cloud-based Computing environment, such as a virtual machine operating within a computing cloud. In other embodiments, the system 1 may itself include a cloud-based computing environment, where the functionalities of the system 1 are executed in a distributed fashion. Thus, the system 1, when configured as a computing cloud, may include pluralities of computing devices in various forms, as will be described in greater detail below.

In general, a cloud-based computing environment is a resource that typically combines the computational power of a large grouping of processors (such as within web servers) that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources. The cloud is formed, for example, by a network of web servers that comprise a plurality of computing devices, such as the computer device 1, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user. It is noteworthy that any hardware platform suitable for performing the processing described herein is suitable for use with the technology.

The terms “computer-readable storage medium” and “computer-readable storage media” as used herein refer to any medium or media that participates in providing instructions to a CPU for execution. Such media can take many forms, including, but not limited to, non-volatile media, volatile media and transmission media.

Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus.

Transmission media can also take the form of acoustic or light waves, such as those generated during radio frequency (RF) and infrared (IR) data communications, as well as wireless communications (both short-range and long-range). Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read. Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Computer program code for carrying out operations for aspects of the present technology may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The foregoing detailed description includes references to the accompanying drawings, which form a part of the detailed description. The drawings show illustrations in accordance with exemplary embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed.

The following detailed description is, therefore, not to be taken in a limiting sense, and the scope is defined by the appended claims and their equivalents. In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls. The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description but is not intended to be exhaustive or limited to the disclosure in the form disclosed. Many modifications and variations will be apparent to those of ordinary skill in the art without departing from the scope and spirit of the disclosure. Exemplary embodiments were chosen and described in order to best explain the principles of the present technology and its practical application, and to enable others of ordinary skill in the art to understand the disclosure for various embodiments with various modifications as are suited to the particular use contemplated.

What is claimed is:

1. A system for cross-device application control using voice commands, the system comprising, a host device comprising a memory storing a routing application including program instructions, and a processor coupled to the memory and configured by the program instructions to:
receive, from a peripheral device, audio data corresponding to a spoken voice command intended to control a target application;
process the audio data to generate a processed representation of the spoken voice command;
retrieve contextual information related to at least one of: a host device environment, user preferences, or a target application state;
transmit the processed representation of the spoken voice command and the contextual information to a remote AI model server;
receive, from the remote AI model server, a structured response generated based on the processed representation of the spoken voice command and the contextual information;
determine whether the host device provides access authorization permitting the routing application to interact with the target application;
upon determining that the host device provides the access authorization, execute, based on the structured response, a control action in the target application; and
upon determining that the host device does not provide the access authorization:
transmit the structured response to the peripheral device;
configure the peripheral device to reformat the structured response according to an accepted input specification; and
transmit the reformatted structured response to the target application
causing execution of the control action in the target application.

2. The system of claim 1, wherein the accepted input specification comprises one of: an HID mouse specification, an HID keyboard specification.

3. The system of claim 1, wherein the processed representation of the audio data corresponding to the spoken voice command is one of: a text transcription of the spoken voice command, a processed audio file including the spoken voice command.

4. The system of claim 1, wherein the processor is further configured by the program instructions to:
upon execution of the control action in the target application:
restart the process by retrieving updated contextual information without receiving a new voice command from the user; and
continuing the process until the AI response determines that no further control actions are necessary to complete the user's request.

5. The system of claim 1, wherein the peripheral device comprises one of: a wireless earbud, a wired headset, a microphone array.

6. The system of claim 1, wherein the access authorization comprises one or more compatibility APIs required to allow the routing application to access the target application.

7. The system of claim 1, wherein the contextual information is collected from the host device environment, and wherein the structured response is generated based on both the text transcription and the contextual information.

8. The system of claim 7, wherein the contextual information comprises at least one of: device state information, user preference information stored on the host device, historical interaction patterns, or environmental data collected by host device sensors.

9. The system of claim 1, wherein the processor is further configured by the program instructions to:
retrieve application-specific contextual information from the target application; and
transmit the application-specific contextual information to the remote AI model server to enhance the relevance of the structured response from the remote AI model server.

10. The system of claim 9, wherein the application-specific contextual information comprises at least one of: current application state, active content being displayed, available functionality, or user-specific configurations within the target application.

11. The system of claim 1, wherein the processor is further configured by the program instructions to:
determine a destination device for the structured response based on user interaction patterns;
select a device-specific transformation module corresponding to the determined destination device;
reformat the structured response according to input requirements specific to the determined destination device;
determine that the processor has access authorization to the determined destination device;
responsive to determining that the processor has access authorization, directly execute the structured response at the determined destination device; and
responsive to determining that the processor lacks access authorization, transmit the reformatted structured response to a peripheral device configured to subsequently transmit the reformatted structured response to the determined destination device.

12. The system of claim 11, wherein reformatting the structured response comprises at least one of:
converting the structured response into a specialized shortcut command when the determined destination device is a mobile application;
adjusting the structured response for compatibility with a desktop operating system when the determined destination device is a laptop computer;
reconfiguring the structured response to comply with a standard audio input format when the determined destination device is a communication device capable of audio transmission.

13. A method for cross-device application control using voice commands, the method comprising:
receiving, at a host device from a peripheral device, audio data corresponding to a spoken voice command intended to control a target application;
processing the audio data to generate a processed representation of the spoken voice command;
retrieving contextual information related to at least one of: a host device environment, user preferences, or a target application state;
transmitting the processed representation of the spoken voice command and the contextual information to a remote AI model server;
receiving, from the remote AI model server, a structured response generated based on the processed representation of the spoken voice command and the contextual information;
determining whether the host device provides access authorization permitting interaction with the target application;
upon determining that the host device provides the access authorization, executing, based on the structured response, a control action in the target application; and
upon determining that the host device does not provide the access authorization:
transmitting the structured response to the peripheral device;
configuring the peripheral device to reformat the structured response according to an accepted input specification; and
transmitting the reformatted structured response to the target application causing execution of the control action in the target application.

14. The method of claim 13, wherein the accepted input specification comprises one of: an HID mouse specification, an HID keyboard specification.

15. The method of claim 13, wherein the processed representation of the audio data corresponding to the spoken voice command is one of: a text transcription of the spoken voice command, a processed audio file including the spoken voice command.

16. The method of claim 13, further comprising: upon execution of the control action in the target application:
retrieving updated contextual information without receiving a new voice command from the user; and
continuing the process until the AI response determines that no further control actions are necessary to complete the user's request.

17. The method of claim 13, wherein the peripheral device comprises one of: a wireless earbud, a wired headset, a microphone array.

18. The method of claim 13, wherein the access authorization comprises one or more compatibility APIs required to allow interaction with the target application.

19. The method of claim 13, wherein the contextual information is collected from the host device environment, and wherein the structured response is generated based on both the text transcription and the contextual information.

20. The method of claim 19, wherein the contextual information comprises at least one of: device state information, user preference information stored on the host device, historical interaction patterns, or environmental data collected by host device sensors.

21. The method of claim 13, further comprising: retrieving application-specific contextual information from the target application; and transmitting the application-specific contextual information to the remote AI model server to enhance the relevance of the structured response from the remote AI model server.

22. The method of claim 21, wherein the application-specific contextual information comprises at least one of: current application state, active content being displayed, available functionality, or user-specific configurations within the target application.

23. The method of claim 13, further comprising:
determining a destination device for the structured response based on user interaction patterns;
selecting a device-specific transformation module corresponding to the determined destination device;
reformatting the structured response according to input requirements specific to the determined destination device;
determining that the processor has access authorization to the determined destination device;
responsive to determining that the processor has access authorization, directly executing the structured response at the determined destination device; and
responsive to determining that the processor lacks access authorization, transmitting the reformatted structured response to a peripheral device configured to subsequently transmit the reformatted structured response to the determined destination device.

24. The method of claim 23, wherein reformatting the structured response comprises at least one of:
converting the structured response into a specialized shortcut command when the determined destination device is a mobile application;
adjusting the structured response for compatibility with a desktop operating system when the determined destination device is a laptop computer;
reconfiguring the structured response to comply with a standard audio input format when the determined destination device is a communication device capable of audio transmission.

25. A non-transitory computer-readable medium storing program instructions that, when executed by a processor of a host device, cause the host device to implement operations comprising:
receiving, at a host device from a peripheral device, audio data corresponding to a spoken voice command intended to control a target application;
processing the audio data to generate a processed representation of the spoken voice command;
retrieving contextual information related to at least one of: a host device environment, user preferences, or a target application state;
transmitting the processed representation of the spoken voice command and the contextual information to a remote AI model server;
receiving, from the remote AI model server, a structured response generated based on the processed representation of the spoken voice command and the contextual information;
determining whether the host device provides access authorization permitting interaction with the target application;
upon determining that the host device provides the access authorization, executing, based on the structured response, a control action in the target application; and
upon determining that the host device does not provide the access authorization:
transmitting the structured response to the peripheral device;
configuring the peripheral device to reformat the structured response according to an accepted input specification; and
transmitting the reformatted structured response to the target application causing execution of the control action in the target application.
